(19) United States
(12) Patent Application Publication
(10) Pub. No.: US 2007/0032290 A1
(43) Pub. Date: Feb. 8, 2007

(54) Gaming machine

(75) Inventors: Yoshinori Saito, Tokyo (JP); Takahiro Murakami, Tokyo (JP); Masahide Aoki, Tokyo (JP); Yusuke Kondo, Tokyo (JP); Takayuki Hara, Tokyo (JP); Kiyotaka Morishima, Tokyo (JP); Shinya Ando, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 11/370,244

(22) Filed: Mar. 8, 2006

(30) Foreign Application Priority Data
Aug. 4, 2005 (JP) 2005-226982

(51) Int. Cl. A63F 13/00

(52) U.S. Cl. 463/20

(57) ABSTRACT

Disclosed is a gaming machine. The gaming machine determines a priority attraction-in ranking depending on an internal winning combination and a type of a symbol, for each of the symbols arranged on the reels, compares the priority attraction-in rankings related to each of the symbols ranging from a symbol located at a predetermined position to symbols within a predetermined range, when the stop operation is detected, and stops rotation of the reels when a symbol having the highest priority attraction-in ranking reaches the predetermined position.

### CROSS REFERENCE TO RELATED APPLICATION

This application is based upon the prior Japanese Patent Applications No. 2005-226982 filed on Aug. 4, 2005 the entire contents of which are incorporated herein by reference.

### BACKGROUND OF THE INVENTION

1. Field of the Invention

The present invention relates to a gaming machine.

2. Description of Related Art

It has been conventionally known a gaming machine, so-called, pachi-slot machine comprising a plurality of reels, each of which having plural symbols arranged on a periphery thereof; plural display windows mounted to correspond to each of the reels and displaying some of the plural symbols arranged on the periphery of each reel so as to allow a player to see them; a start switch for outputting a signal requesting start of rotation of each reel, based on an operation by the player (hereinafter, referred to as ┌start operation┘), on condition that a medal has been inserted; a stop switch for outputting a signal requesting stop of the rotation of the reel, correspondingly to types of the reels, based on an operation by the player (hereinafter, referred to as ┌stop operation┘); and a control unit for controlling an operation of a stepping motor to rotate and stop the respective reels, based on the signals outputted from the start switch and the stop switch. In the pachi-slot machine, it is determined whether a winning is achieved on the basis of a combination of symbols displayed by the display windows, and a medal is paid out when it is determined that a winning is achieved.

At present time, in the pachi-slot machine forming the mainstream, if the start operation is carried out, an internal lottery is performed and an operation of stopping the reel rotation is carried out, based on a result of the lottery and the timing of the stop operation. Accordingly, even though a result relating to a winning is determined by the internal lottery (hereinafter, a type of the internal lottery result will be referred to as ┌internal winning combination┘), if the stop operation is not carried out at an appropriate timing, a winning is not achieved. Accordingly, it is necessary for a player to have a skill, i.e., so-called observation push.

In recent years, it has been suggested a gaming machine wherein when the stop operation is detected, it is retrieved a position in a predetermined retrieval order at which a combination of symbols relating to an internal winning combination can be displayed, and the stop control for the reel is carried out on the basis of the first position (for example, see a Japanese Unexamined Patent Publication No. Hei 10-15156).

However, according to the conventional gaming machine, since the stop control of the reel being rotated is carried out on the basis of the first position, if it is determined, based on a predetermined retrieval order, a position at which a combination of symbols relating to an internal winning combination can be displayed, it is not determined whether there is a different position at which the combination of symbols relating to the internal winning combination can be displayed, in the retrieval order after that. In other words, it is not retrieved all the positions at which the combination of symbols relating to the internal winning combination can be displayed.

For example, in case that plural types of internal winning combinations are determined at the same time, when it is determined a position at which a combination of symbols relating to an internal winning combination can be displayed, the stop control of the reel being rotated is carried out without determining whether there is a position at which a combination of symbols relating to another internal winning combination can be displayed.

Accordingly, even though there are the payout numbers of medals as many as the combinations of symbols relating to the other internal winning combinations are displayed, the combinations are excluded from being displayed, so that it is caused a disadvantage to a player.

### SUMMARY OF THE INVENTION

Accordingly, the invention has been made to solve the above-mentioned problems occurring in the prior art. An object of the invention is to provide a gaming machine capable of embodying a proper advantage to be naturally awarded to a player.

In order to achieve the above object, according to the invention, there is provided a gaming machine comprising: plural reels, each of which having plural symbols arranged on a periphery thereof and displaying the symbols; start operation detection means for detecting a start operation; internal winning combination determining means for determining an internal winning combination on the basis of the start operation detection carried out by the start operation detection means; reel rotation means for rotating the reels; priority ranking determining means for determining a priority attraction-in ranking, based on an internal winning combination determined by the internal winning combination determining means and a type of the symbol, for each of the symbols arranged on the reels; stop operation detection means for detecting a stop operation; symbol specifying means for specifying a symbol of a predetermined position; priority ranking comparison means for comparing the priority attraction-in rankings related to each of the symbols ranging from a symbol specified by the symbol specifying means to symbols within a predetermined range, when the stop operation is detected by the stop operation detection means; and reel stop means for stopping rotation of the reels when a symbol having the highest priority attraction-in ranking as a result of the comparison carried out by the priority ranking comparison means reaches the predetermined position.

According to the above gaming machine, the priority attraction-in ranking is determined for each of the symbols arranged on the reels, the priority attraction-in rankings related to each of the symbols ranging from a symbol specified by the symbol specifying means to symbols within a predetermined range are compared when the stop operation is detected, and the rotation of the reels is stopped when the symbol having the highest priority attraction-in ranking reaches the predetermined position. In other words, when the stop operation is detected, it is possible to determine the most suitable symbol among all the symbols ranging from the symbol of predetermined position to the symbols within a predetermined range and to stop the rotation of the reels based on the symbol determined. Accordingly, it is possible to prevent the payout to be awarded to a player from being lost.

In addition, according to the invention, the gaming machine may further comprise priority attraction-in ranking table memorizing means for memorizing a priority attraction-in ranking table defining the priority rankings in accordance with internal winning combinations, wherein the priority ranking determining means may determine the priority attraction-in ranking depending on the internal winning combination determined by the internal winning combination determining means and the type of the symbol, for each of the symbols arranged on the reels, based on the priority attraction-in ranking table memorized by the priority attraction-in ranking table memorizing means.

According to the above gaming machine, the priority attraction-in ranking depending on the internal winning combination determined by the internal winning combination determining means and the type of the symbol is determined for each of the symbols arranged on the reels, based on the priority attraction-in ranking table defining the priority rankings in accordance with the internal winning combinations. Accordingly, in addition to the effect described above, it is possible to cope with a change of the gaming machine just by changing the priority rankings defined in the priority attraction-in table. In addition, since it is possible to group the internal winning combinations to define the same priority ranking even for the different internal winning combinations, it is possible to reduce values which will be the priority attraction-in rankings and thus to decrease the data capacity.

In addition, according to the invention, the priority ranking determining means may determine the priority attraction-in ranking depending on the internal winning combination determined by the internal winning combination determining means, the type of the symbol and types of symbols adjacent to the corresponding symbol, for each of the symbols arranged on the reels.

According to the above gaming machine, it is determined the priority attraction-in ranking depending on the internal winning combination determined, the type of the symbol and types of symbols adjacent to the corresponding symbol, for each of the symbols arranged on the reels. In other words, in addition to the above effects, since it is referred to not only the type of one symbol and but also types of the symbols adjacent to the symbol when determining the priority attraction-in ranking, it is possible to determine the priority attraction-in rankings more specifically, as compared to a case where the priority attraction-in ranking is determined on the basis of the type of one symbol only.

### BRIEF DESCRIPTION OF THE DRAWINGS

Other and further objects, features and advantages of the invention will appear more fully from the following description taken in connection with the accompanying drawings, in which:

FIG. 1 is a perspective view of schematically showing a gaming machine 1 according to an embodiment of the invention; provided to a gaming machine;

FIG. 2 is ja view showing an example of symbols arranged on reels 3L, 3C, 3R providing to a gaming machine;

FIG. 3 is a block diagram of an electric circuit of the gaming machine 1;

FIG. 4 is a view showing a symbol arrangement table of the gaming machine 1;

FIG. 5 is a view showing an internal lottery table determining table of the gaming machine 1;

FIG. 6A shows an internal lottery table of the gaming machine 1;

FIG. 6B shows an internal lottery table of the gaming machine 1;

FIG. 7 shows an internal winning combination determining table of the gaming machine 1;

FIG. 8 shows a reel stop initialization table of the gaming machine 1;

FIG. 9 is a view showing a symbol combination table selecting table A for stop-control of the gaming machine 1;

FIG. 10 is a view showing a symbol combination table selecting table B for stop-control of the gaming machine 1;

FIG. 11 shows a symbol combination table for stop-control of the gaming machine 1;

FIG. 12 shows a priority attraction-in ranking table of the gaming machine 1;

FIG. 13A is a view showing a retrieval parameter table of the gaming machine 1;

FIG. 13B is a view showing a retrieval parameter table of the gaming machine 1;

FIG. 14 shows a retrieval order table determining table of the gaming machine 1

FIG. 15 shows a symbol combination table of the gaming machine 1;

FIG. 16 shows a table on bonus operation of the gaming machine 1;

FIG. 17 shows an internal winning combination storing area of a RAM 33 included in a main control circuit 71;

FIG. 18 shows an internal carryover combination storing area of the RAM 33 included in the main control circuit 71;

FIG. 19 is a view showing an area for storing a winning combination for reel-stop of the RAM 33 included in the main control circuit 71;

FIG. 20 is a view showing a select counter for stop of the RAM 33 included in the main control circuit 71;

FIG. 21 is a view showing a symbol storing area of the RAM 33 included in the main control circuit 71;

FIG. 22 is a view showing an expected display combination storing area of the RAM 33 included in the main control circuit 71;

FIG. 23A is a view showing a storing example of an expected display combination storing area of the RAM 33 included in the main control circuit 71;

FIG. 23B is a view showing a storing example of an expected display combination storing area of the RAM 33 included in the main control circuit 71;

FIG. 24 is a flow chart showing a RESET intervention process carried out by the main control circuit 71;

FIG. 25 is flow chart showing a medal receiving×start checking process by the main control circuit 71;

FIG. 26 is a flow chart showing an internal lottery process by the main control circuit 71;

FIG. 27 is a flow chart showing a reel stop initialization process by the main control circuit 71;

FIG. 28 is a flow chart showing an expected display combination storing process by the main control circuit 71;

FIG. 29 is a flow chart showing an expected display combination storing process following FIG. 28;

FIG. 30 is a flow chart showing a display combination retrieving process by the main control circuit 71;

FIG. 31 is a flow chart showing a reel stop control process by the main control circuit 71;

FIG. 32 is a flow chart showing a priority attraction-in control process by the main control circuit 71;

FIG. 33 is a flow chart showing a process of selecting an expected display combination storing area following FIG. 28;

FIG. 34 is a flow chart showing a bonus operation checking process by the main control circuit 71;

FIG. 35 is a flow chart showing a bonus end checking process by the main control circuit 71; and

FIG. 36 is a flow chart showing an intervention process having a period of 1.1173 msec by the main control circuit.

### DESCRIPTION OF THE PREFERRED EMBODIMENTS

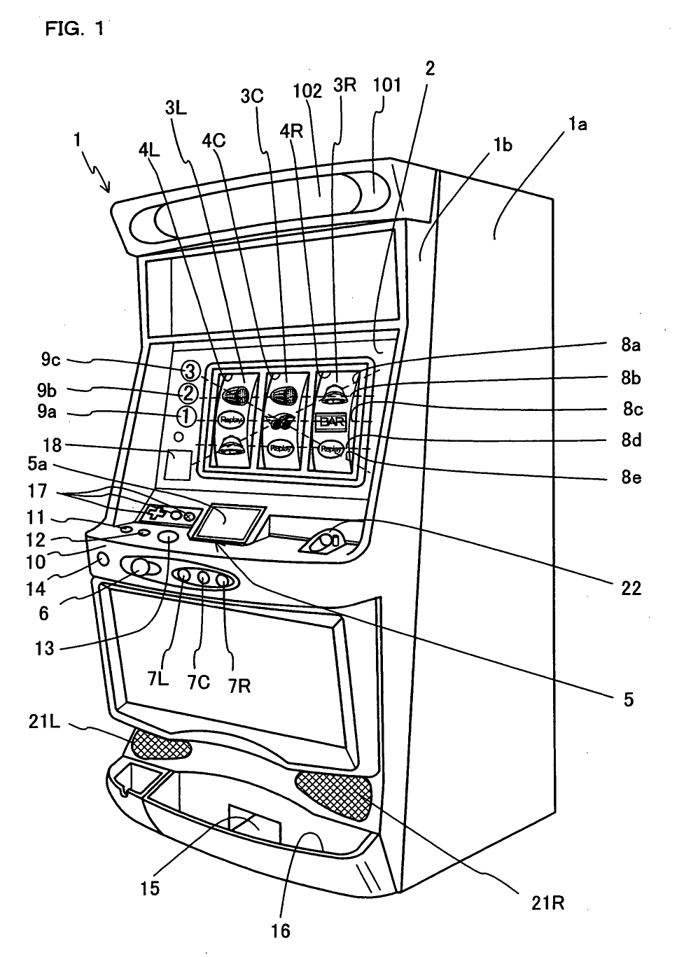

Hereinafter, it will be described a preferred embodiment of the present invention with reference to the drawings. First, a gaming machine 1 according to an embodiment of the invention is schematically described with reference to FIG. 1.

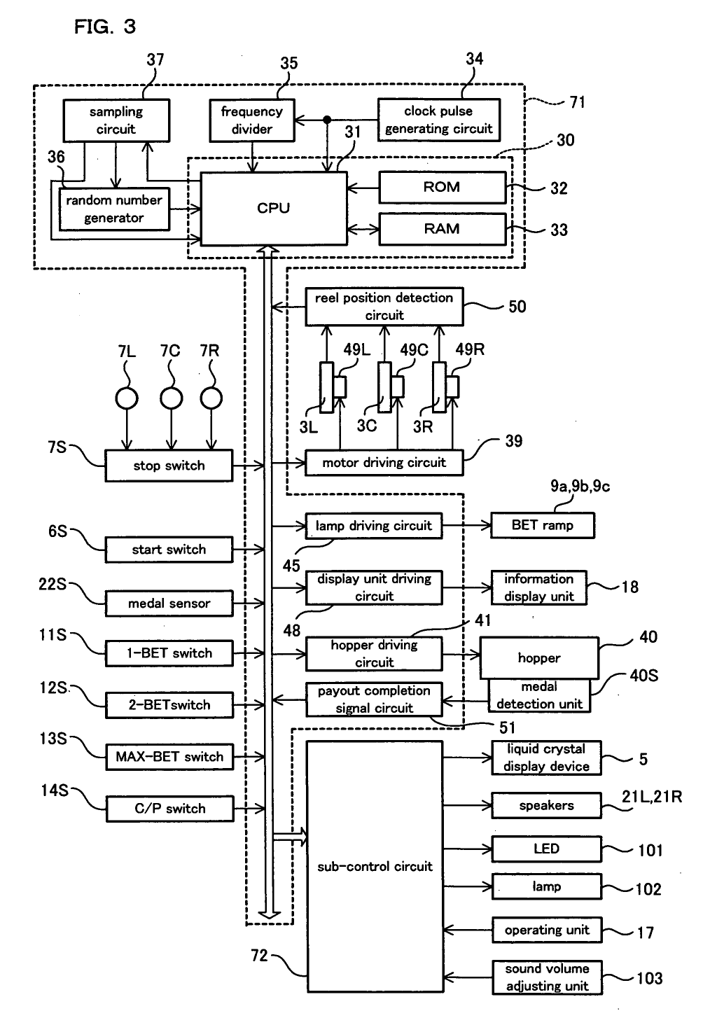

The gaming machine 1 comprises a cabinet 1a receiving reels 3L, 3C, 3R, a main control circuit 71 (see FIG. 3) and the like which will be described later, and a front door 1b which is mounted to be opened and closed with regard to the cabinet 1a.

The three reels 3L, 3C, 3R are horizontally mounted in a row in the cabinet 1a. In addition, plural symbols are continuously arranged in a rotation direction of the reel on a periphery of each of the reels 3L, 3C, 3R. Each of the reels 3L, 3C, 3R is controlled to rotate at a constant speed (for example, 80 revolutions/minute) by the main control circuit 71 which will be described later. The plural symbols arranged on the peripheries of the reels 3L, 3C, 3R are varied as the reels are rotated.

In addition, a panel display unit 2 having an approximately horizontal surface is provided to the front door 1b, and three display windows 4L, 4C, 4R having a rectangular shape are mounted to a center of the panel display unit 2, as symbol display areas. Each of the display windows 4L, 4C, 4R is mounted to be located before the corresponding reels 3L, 3C, 3R, so that it is possible to observe the rotation and stopping of the reels 3L, 3C, 3R through the display windows 4L, 4C, 4R. In addition, one symbol is displayed in each of the upper, central and lower areas of the respective display windows 4L, 4C, 4R, so that three symbols of the symbols arranged on the corresponding reels are displayed in the respective display windows 4L, 4C, 4R. In the mean time, the display windows 4L, 4C, 4R constitute a part of symbol display means, together with the reels 3L, 3C, 3R.

In addition, pay lines are formed in the display windows 4L, 4C, 4R, which connect predetermined areas of the upper, central and lower areas of the respective display windows 4L, 4C, 4R. The pay lines include a top line 8b, a center line 8c, a bottom line 8d, a cross-up line 8a and a cross-down line 82.

The center line 8c is a line connecting the central areas of the respective display windows 4L, 4C, 4R each other. The top line 8b is a line connecting the upper areas of the respective display windows 4L, 4C, 4R each other. The bottom line 8d is a line connecting the lower areas of the respective display windows 4L, 4C, 4R each other. The cross-up line 8a is a line connecting the lower area of the left display windows 4L, the central area of the center display window 4C and the upper area of the right display window 4R each other. The cross-down line 8e is a line connecting the upper area of the left display windows 4L, the central area of the center display window 4C and the lower area of the right display window 4R each other.

These pay lines 8a to 8e are activated by manipulating one of 1-BET switch 11, a 2-BET switch 12 and a MAX-BET switch 13 or inserting a medal into a medal insertion slot 22 which will be described later (the line activated is hereinafter referred to as ┌activated line┘).

A medal insertion slot 22 for inserting a medal into the gaming machine 1 is provided to a right side of a liquid crystal display device 5. When the medal is inserted through the medal insertion slot 22, the pay line is activated. When the three medals are continuously inserted, they are deposited (i.e., credited) in the gaming machine 1. In the mean time, the gaming machine 1 uses a medal as a game medium. However, the game medium used in the gaming machine 1 is not limited to the medal, and a coin, a gaming ball, a token, a card storing information about an amount of the medals, and the like may be applied.

A 1-BET button 11, a 2-BET button 12 and a MAX-BET button 13 for determining the number of medals inserted for a unit game (for example, one game from after the reels are started to rotate until the rotation of reels is stopped and thus a result of game is obtained) from the credited medals are mounted to a left side of the liquid crystal display device 5. When the 1-BET button 11 is pushed, one piece is inserted from the medals credited, when the 2-BET button 12 is pushed, two pieces are inserted, and when the MAX-BET button 13 is pushed, three pieces are inserted.

To the left side of the display windows 4L, 4C, 4R are mounted a 1-BET lamp 9a, a 2-BET lamp 9b and a MAX-BET lamp 9c. The 1-BET lamp 9a, 2-BET lamp 9b and MAX-BET lamp 9c are turned on in correspondence with the number of medals inserted in the unit game (hereinafter, referred to as ┌insertion number┘). When the insertion number is one, two and three pieces, the 1-BET lamp 9a, the 2-BET lamp 9b and the MAX-BET lamp 9c are turned on, respectively.

An information display unit 18 is mounted below the BET lamps 9a, 9b, 9c. The information display unit 18 consists of 7 segment LEDs and displays the number of medals deposited (so-called ┌credited┘) in the gaming machine 1, the number of medals to be paid out to a player (hereinafter, referred to as ┌payout number┘) and the like.

A base portion 10 having a horizontal surface is provided below the display windows 4L, 4C, 4R, and the liquid crystal display device 5 is provided between the base portion 10 and the display windows 4L, 4C, 4R. The information about the game, etc. IVUS displayed on a display screen 5a of the liquid crystal display device 5.

An operating unit 17 is mounted above the BET buttons 11, 12, 13, which consists of a cross key, a selection button and a determination button. Based on a manipulation of the operating unit 17 by the player, the information about the game such as game history is displayed on display screen 5a of the liquid crystal display device 5.

A C/P button 14 for switching credits (Credit) or payouts (Pay) of medals is mounted to a frontal left side of the base portion 10. In case that the payout is carried out, the medals as the payout number are paid out from a frontal lower medal payout slot 15 and stacked on a medal tray 16. In addition, in case that the credit is carried out, the medals as the payout number are credited. Herein, the payout and credit of the medal may be simply referred to as ┌payout┘.

To a right side of the C/P button 14 is mounted a start lever 6 for rotating the reels 3L, 3C, 3R and starting the variation of the symbols displayed in the display windows 4L, 4C, 4R.

Stop buttons 7L, 7C, 7R which are mounted to correspond to the reels 3L, 3C, 3R and stop the rotation of the reels 3L, 3C, 3R are mounted below the liquid crystal display device 5, in the frontal center of the base portion 10.

Hereinafter, a stop operation which is first of all carried out when all the reels 3L, 3C, 3R are rotated (i.e., a player's push operation for the stop buttons 7L, 7C, 7R) will be referred to as ┌first stop operation┘, a stop operation which is carried out following the first stop operation when the two reels are rotated will be referred to as ┌second stop operations┘, and a stop operation which is carried out following the second stop operation when the remaining one reel is rotated will be referred to as ┌third stop operations┘.

A LED 101 and a lamp 102 are mounted at the upper part of the front door 1b. The LED 101 and the lamp 102 emit lights with a radiation pattern corresponding to game situations, and perform an effect relating to a game.

Speakers 21L, 21R are mounted at upper left and right sides of the medal tray 16. Sound such as effect sound or sing corresponding to the game situations is outputted from the speakers 21L, 21R to perform the effect relating to a game.

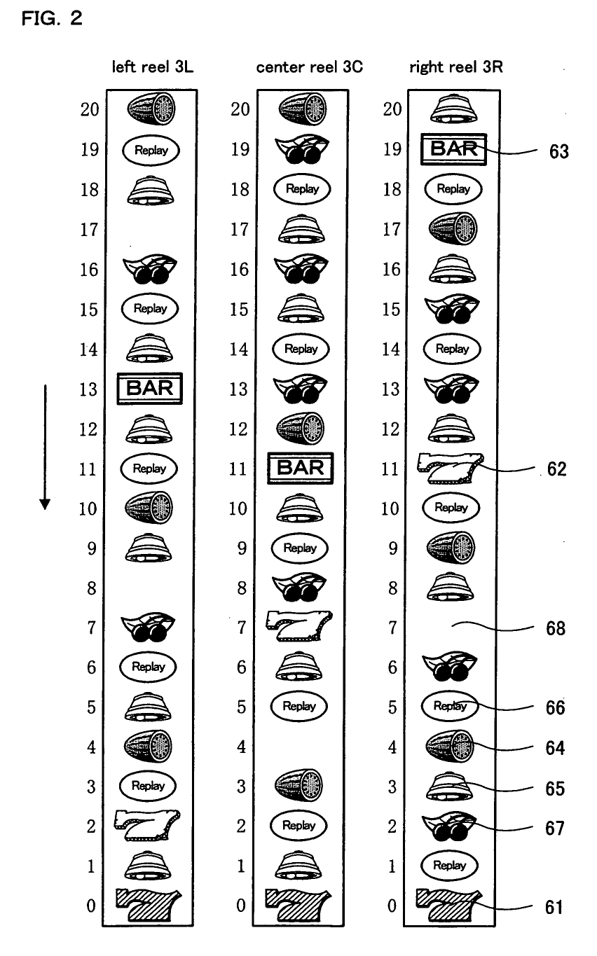

In the followings, it is described symbols arranged on the reels 3L, 3C, 3R, with reference to FIG. 2.

The plural types of 21 symbols are arranged on the respective reels 3L, 3C, 3R. Specifically, 21 areas are provided on the periphery of each of the reels 3L, 3C, 3R, each of which being allotted with a one symbol. Each symbol of Red 7 (symbol 61), Blue 7 (symbol 62), BAR (symbol 63), Watermelon (symbol 64), Bell (symbol (65), Replay (symbol 66), Cherry (symbol 67) and Blank (symbol 68) is arranged on each of the corresponding areas. In the mean time, Blank (symbol 68) is expressed by space. Each of the reels 3L, 3C, 3R is rotated in an arrow direction of FIG. 2.

In the followings, it is described a circuit structure of the gaming machine 1 comprising a main control circuit 71, a sub-control circuit 72 and a peripheral device (e.g., actuator) electrically connected to the main control circuit 71 or a sub-control circuit 72, with reference to FIG. 3.

The main control circuit 71 comprises a micro computer 30 arranged on a circuit board as a main constituting element and is further provided with a circuit for sampling random numbers. The micro computer 30 includes a CPU 31 and a ROM 32 and a RAM 33 which are memory means.

To the CPU 31 is connected a clock pulse generating circuit 34, a frequency divider 35, a random number generator 36 and a sampling circuit 37. The clock pulse generating circuit 34 and the frequency divider 35 generate a reference clock pulse. Based on the generated reference clock pulse, an intervention process which will be described later is carried out. The random number generator 36 generates a random number within a predetermined range (for example, 0˜65535). The sampling circuit 37 extracts (samples) one random number from the random numbers generated by the random number generator 36. By using the sampled random number, an internal lottery process and the like are carried out, which will be described later, and predetermined information (for example, winning number) is determined.

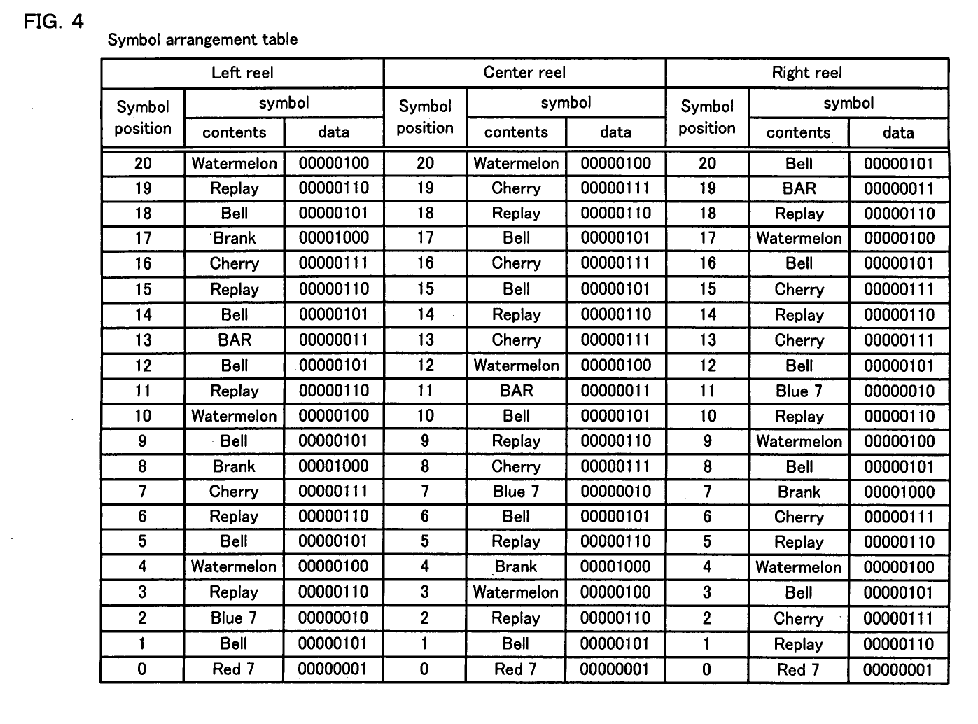

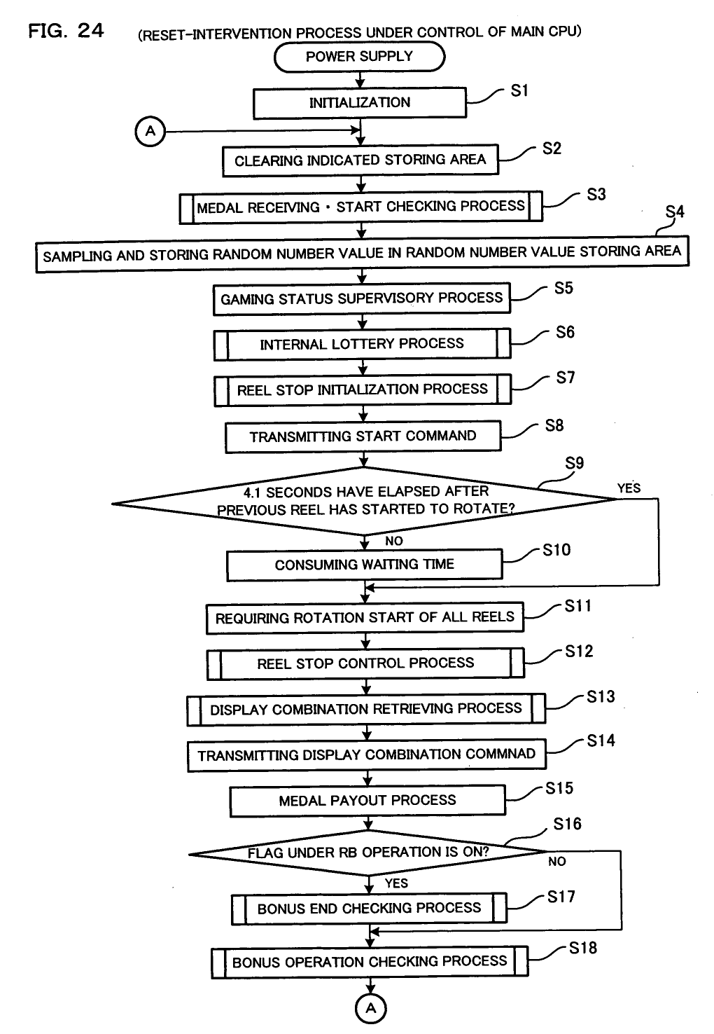

The ROM 32 of the micro computer 30 memorizes programs relating to processes of the CPU 31 (see FIGS. 24 to 36), various tables such as priority attraction-in ranking table and retrieval order table (see FIGS. 4 to 16), and various control commands for being transmitted to the sub-control circuit 72. In the mean time, the ROM 32 constitutes a part of priority attraction-in ranking table memorizing means. In addition, the ROM 32 constitutes a part of retrieval order table memorizing means.

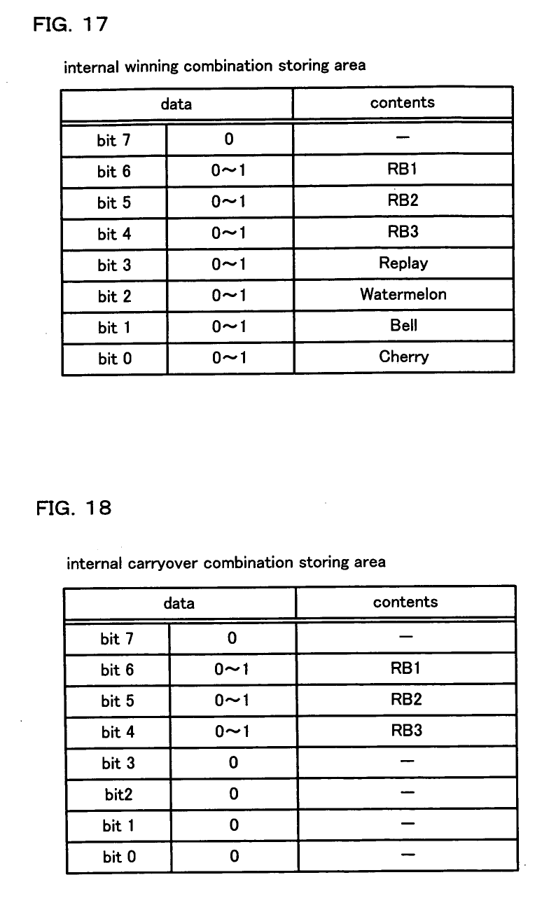

Various data obtained from the processes of the CPU 31 is memorized in the RAM 33. For example, an area (see FIGS. 17 to 23) for storing priority attraction-in ranking data relating to each symbol position is provided therein. These data are transmitted to the sub-control circuit 72 by the commands.

In the circuit shown in FIG. 3, main actuators controlled by a control signal from the micro computer 30 include the BET lamps 9a, 9b, 9c, the information display unit 18, a hopper 40, stepping motors 49L, 49C, 49R and the like.

In addition, to an output unit of the micro computer 30 are connected each of circuits for receiving the control signals outputted from the CPU 31 to control the operations of the respective actuators. The circuits include a motor driving circuit 39, a lamp driving circuit 45, a display unit driving circuit 48 and a hopper driving circuit 41.

The lamp driving circuit 45 controls the driving of the BET lamps 9a, 9b, 9c. Thereby, the BET lamps 9a, 9b, 9c are turned on or off.

The display unit driving circuit 48 controls the driving of the information display unit 18. Thereby, various information (credit number, etc.) IVUS displayed on the information display unit 18.

The hopper driving circuit 41 controls the driving of the hopper 40. Thereby, the medals received in the hopper 40 are paid out.

The motor driving circuit 39 outputs the pulse coming from the main control circuit 71 to the stepping motors 49L, 49C, 49R and controls the driving of the stepping motors 49L, 49C, 49R. Thereby, the reels 3L, 3C, 3R are rotated and stopped.

In this embodiment, it is counted the number of pulses outputted to the stepping motors 49L, 49C, 49R from after a reel index indicating one revolution of the reel is detected by a reel position detection circuit 50, so that a rotation angle of the reel is detected on the basis of the detected position of the reel index. In addition, the pulse is outputted 16 times to the stepping motors 49L, 49C, 49R, so that the reel is rotated as a one symbol arranged on the periphery of the reel.

More specifically, the number of pulses outputted to the stepping motors 49L, 49C, 49R is counted by a pulse counter of the RAM 33, and a symbol counter of the RAM 33 is added by one whenever 16 times of pulse outputs are counted by the pulse counter. In addition, a value of the symbol counter is cleared whenever the reel index is detected.

Each of the symbols arranged on the periphery of the reel is defined with symbol positions ┌0┘˜┌20┘ for discriminating each of the symbols in regular order from the rotation direction of the reel. The reel index is detected by a reel position detection circuit 50 so that the symbol corresponding to the symbol position ┌0┘ is located on the center line 8c (more specifically, center part of the longitudinal direction of the respective display windows 4L, 4C, 4R).

In other words, when the value of the symbol counter becomes ┌0┘ by the detection of the reel index, the symbol corresponding to the symbol position ┌0┘ is located on the center line 8c, so that the symbol counter and the symbol position correspond to each other. Accordingly, by referring to the symbol counter, it is possible to specify the symbol located on the center line 8c. In the mean time, the symbol counter constitutes a part of symbol specifying means. In addition, the center line 8c is an example of a predetermined position at which the symbol specifying means specifies a symbol.

To an input unit of the micro computer 30 are connected switches and the like which output predetermined signals performing the controls of the actuators. Specifically, a start switch 6S, a stop switch 7S, a 1-BET switch 11S, a 2-BET switch 12S, a MAX-BET switch 13S, a C/P switch 14S, a medal sensor 22S, the reel position detection circuit 50 and a payout completion signal circuit 51 are connected.

The start switch 6S detects the start operation of the player for the start lever 6 and outputs a detected signal to the micro computer 30. In the mean time, the start switch 6S constitutes a part of start operation detection means.

The stop switch 7S detects the stop operation of the player for the respective stop buttons 7L, 7C, 7R and outputs a detected signal to the micro computer 30. In the mean time, the stop switch 7S constitutes a part of stop operation detection means.

The 1-BET switch 11S, the 2-BET switch 12S and the MAX-BET switch 13S detect the insertion operations of the player for the 1-BET button 11, the 2-BET button 12 and the MAX-BET button 13, respectively, and output a detected signal to the micro computer 30.

The C/P switch 14S detects the switching operation of the player for the C/P button 14 and outputs a detected signal to the micro computer 30.

The medal sensor 22S detects a medal inserted into the medal insertion slot 22 by the player and outputs a detected signal to the micro computer 30

The reel position detection circuit 50 detects the reel index indicating one revolution of the reel for each of the reels 3L, 3C, 3R and outputs a detected signal to the micro computer 30.

The payout completion signal circuit 51 detects that the number of medals (i.e., the number of medals paid out from the hopper 40) reaches an indicated payout number through a medal detection unit 40S and outputs a detected signal to the micro computer 30.

The sub-control circuit 72 executes various processes (for example, determination or execution of contents of effect), based on the various commands (for example, start command) outputted from the main control circuit 71. In the mean time, the sub-control circuit 72 does not input the command, the information, etc. to the main control circuit 71. In other words, the communication of the main control circuit 71 and the sub-control circuit 72 is carried out in a one-way manner, from the main control circuit 71 to the sub-control circuit 72.

The main actuators controlled by the sub-control circuit 72 include the liquid crystal display device 5, the speakers 21L, 21R, the LED 101 and the lamp 102. The sub-control circuit 72 determines and displays an image to be displayed on the liquid crystal display device 5, determines and outputs a lighting-up pattern of the LED 101 or lamp 102, and determines and outputs effect sound, based on the contents of effect determined.

The sub-control circuit 72 is connected with the operating unit 17 and a sound volume adjusting unit 103 and outputs an image or sound, based on the signal outputted from them.

In the followings, a symbol arrangement table is described with reference to FIG. 4.

The symbol arrangement table shows the symbols arranged on the peripheries of the reels 3L, 3C, 3R, as data. In other words, the symbol arrangement table defines Red 7, Blue 7, BAR, Watermelon, Replay, Cherry and Blank in an arrangement as shown in FIG. 2.

In addition, with the symbol located on the center line 8c being defined as the symbol position ┌0┘ when the reel index is detected, the symbol arrangement table defines the symbol positions ┌0┘ to ┌20┘ corresponding to the symbol counter and types of symbols corresponding to the respective symbol positions. Accordingly, based on the symbol arrangement table and the symbol counter, symbols of the respective reels 3L, 3C, 3R on the center line 8c and types thereof can be specified. For example, when the symbol counter of the right reel 3R is ┌11┘, it is specified that Blue 7 (symbol 62) of the symbol position ┌11┘ of the right reel 3R is located on the center line 8c. In addition, by referring to the symbol counter and the symbol arrangement table, besides the symbol located on the center line 8c, it is possible to specify symbols adjacent to the corresponding symbol and types thereof. In the mean time, the symbol arrangement table constitutes a part of symbol specifying means.

In addition, a type of a symbol corresponding to each symbol position is represented by 1 byte data. For example, the data representing Red 7 is ┌00000001┘ and the data representing Blue 7 is ┌00000010┘, the data representing BAR is ┌00000011┘, the data representing Watermelon is ┌00000100┘, the data representing Bell is ┌00000101┘, the data representing Replay is ┌000000110┘, the data representing Cherry is ┌00000111┘ and the data representing Blank is ┌00001000┘.

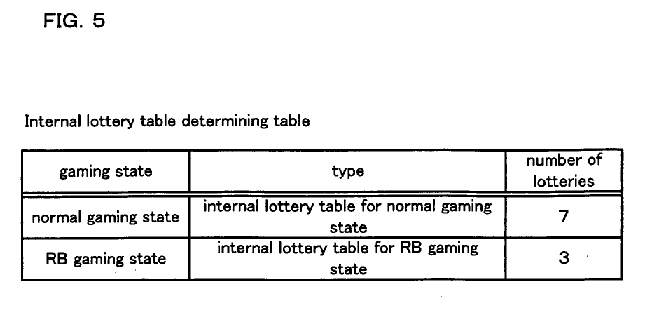

In the followings, an internal lottery table determining table is described with reference to FIG. 5.

The internal lottery table determining table defines a type of an internal lottery table and the number of lotteries, which are determined in accordance with the gaming states. In a normal gaming state, it is determined an internal lottery table for normal gaming state and the number of lotteries is basically determined to be 7. In a RB gaming state, it is determined an internal lottery table for RB gaming state and the number of lotteries is determined to be 3.

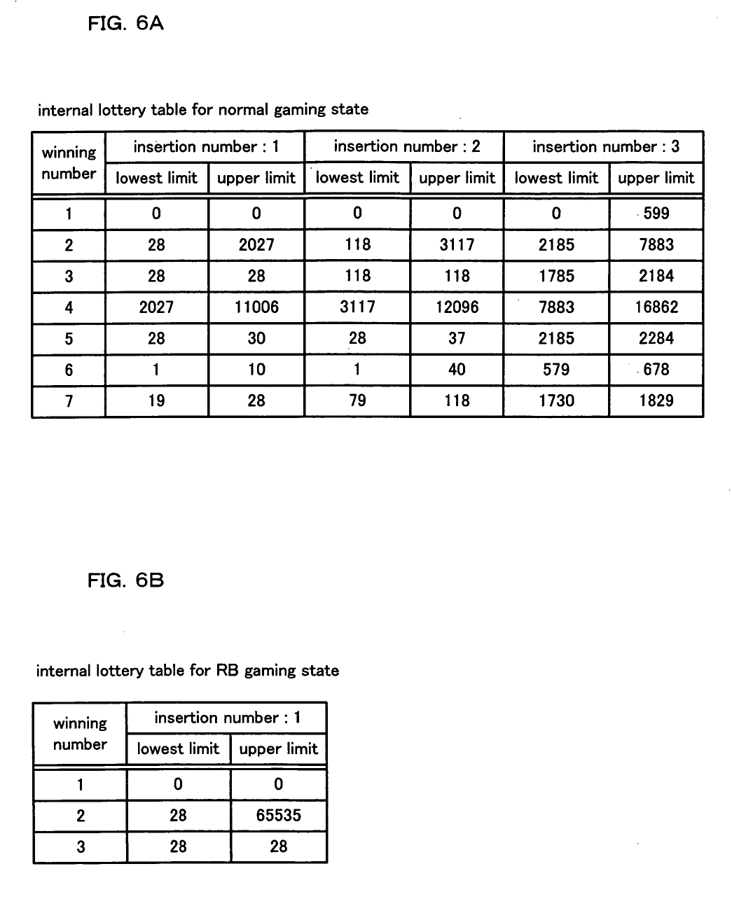

In the followings, an internal lottery table is described with reference to FIG. 6.

The internal lottery table defines the lowest and upper limits of random numbers allotted in accordance with each of winning numbers. The winning number is data used to determine an internal winning combination on the basis of an internal winning combination determining table which will be described later.

In the internal lottery table, it is retrieved whether the random number value sampled from a range of ┌0˜65535┘ is included between the lowest limit and the upper limit of the random numbers allotted to the respective winning numbers, in descending power of the winning numbers. In case that the sampled random number value is included between the lowest limit and the upper limit, a corresponding winning number is determined. The number of lotteries indicates the number of the above retrievals. As a result of performing the retrieval as the number of lotteries, when any winning number is not matched, the winning number 0 (i.e., Losing) is determined.

FIG. 6A shows an internal lottery table for normal gaming state. In the internal lottery table for normal gaming state, the lowest and upper limits of the random number value allotted to each of the winning numbers 1˜7 are defined in correspondence with the insertion numbers 1 to 3. A winning probability of each winning number can be calculated by ┌(1+difference between the lowest and upper limits defined for each winning number)/the number of all random number values occurring (65536) in the table┘. In the internal lottery table for normal gaming state, the greater the insertion number, the higher the winning probability by stages.

In the internal lottery table for normal gaming state, there is defined a value duplicating for the plural winning numbers. When a random number included in the duplicating value is sampled, the plural winning numbers are together determined in one unit game.

For example, in case of the insertion number of 3, when a sampled random number is within a range of ┌1785˜1829, the winning number 3 (i.e., Watermelon) and the winning number 7 (i.e., RB1) are determined together.

FIG. 6B shows an internal lottery table for RB gaming state. In the RB gaming state, the maximum insertion number is determined to be 1 piece. Accordingly, in the internal lottery table for RB gaming state, it is defined the lowest and upper limits corresponding to each of the winning numbers 1 to 5, with regard to the insertion number 1 only. In the internal lottery table for RB gaming state, the winning probability of the winning number 2 (i.e., Bell) is very high.

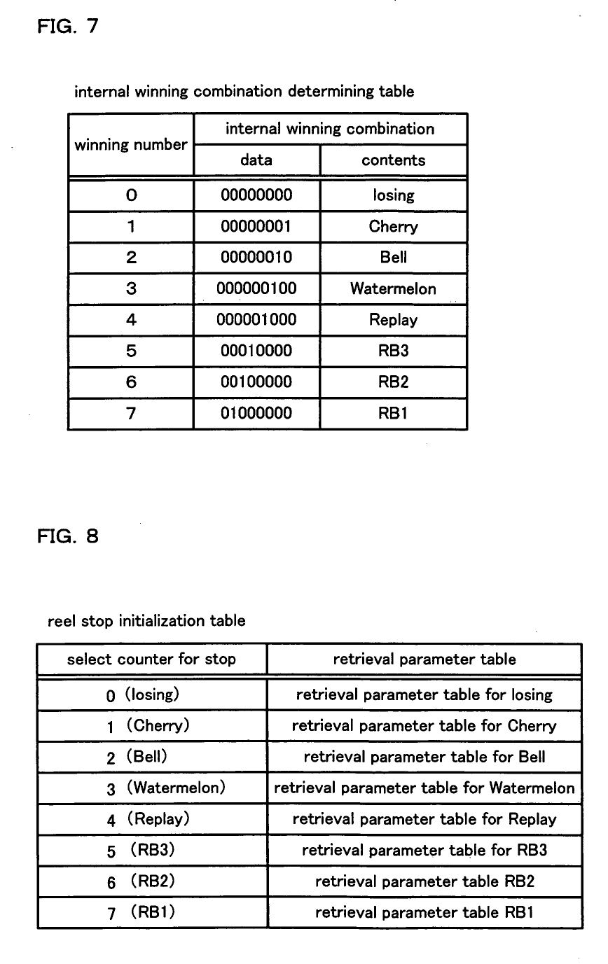

In the followings, an internal winning combination determining table is described with reference to FIG. 7.

The internal winning combination determining table defines an internal winning combination in relation to the winning number. Specifically, each of Losing, Cherry, Bell, Watermelon, Replay, Regular Bonus (hereinafter, abbreviated as ┌RB┘) 3, RB2 and RB1 is defined in correspondence with each of the winning numbers 0˜7. In other words, if a winning number is determined by the internal lottery table, an internal winning combination is determined in accordance with the corresponding winning number. Accordingly, it can be said that the determination of the winning number is equivalent to the determination of the internal winning combination.

In addition, a type of each internal winning combination is expressed by 1 byte data. For example, the data representing Losing is ┌00000000┘, the data representing Cherry is ┌00000001┘, the data representing Bell is ┌00000010┘, the data representing Watermelon is ┌00000100┘, the data representing Replay is ┌00001000┘, the data representing RB3 is ┌00010000┘, the data representing RB2 is ┌00100000┘ and the data representing RB1 is ┌01000000┘. In other words, a bit string corresponding to a type of each internal winning combination becomes ON (i.e., 1 is set).

In the followings, a reel stop initialization table is described with reference to FIG. 8.

The reel stop initialization table defines a type of a retrieval parameter table in correspondence with a select counter for stop. The select counter for stop is data for determining a retrieval parameter table which will be described later and basically identical to the winning number. Specifically, it is defined retrieval parameter tables corresponding to each of Losing, Cherry, Bell, Watermelon, Replay, RB3, RB2 and RB1, in correspondence with each of the select counters for stop 0 to 7.

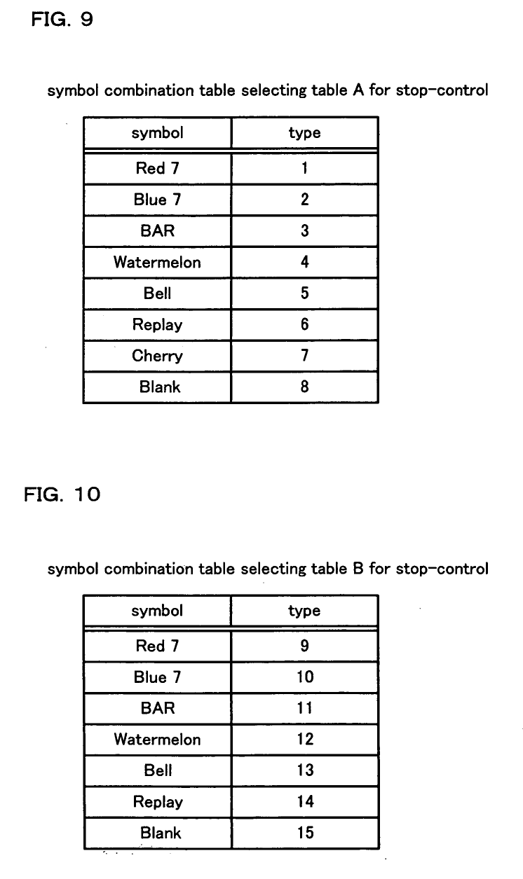

In the followings, it is described a symbol combination table selecting table for stop-control, with reference to FIGS. 9 and 10.

A symbol combination table selecting table A for stop-control shown in FIG. 9 is used when a reel (hereinafter, referred to as ┌retrieval target reel┘), for which it is retrieved display combinations capable of being established at the symbol positions ┌0┘˜┌20┘, is the left reel 3L. In addition, a symbol combination table selecting table B for stop-control shown in FIG. 10 is used when the retrieval target reel is the center reel 3C or right reel 3R.

The symbol combination table selecting table for stop-control defines a type of the symbol combination table selecting table for stop-control in relation with each type of the symbols. The symbol combination table selecting table A for stop-control defines each of types 1 to 8 in correspondence with each types of symbols, i.e., Red 7, Blue 7, BAR, Watermelon, Bell, Replay, Cherry and Blank. The symbol combination table selecting table B for stop-control defines each of types 9 to 15 in correspondence with each types of symbols, i.e., Red 7, Blue 7, BAR, Watermelon, Bell, Replay and Blank.

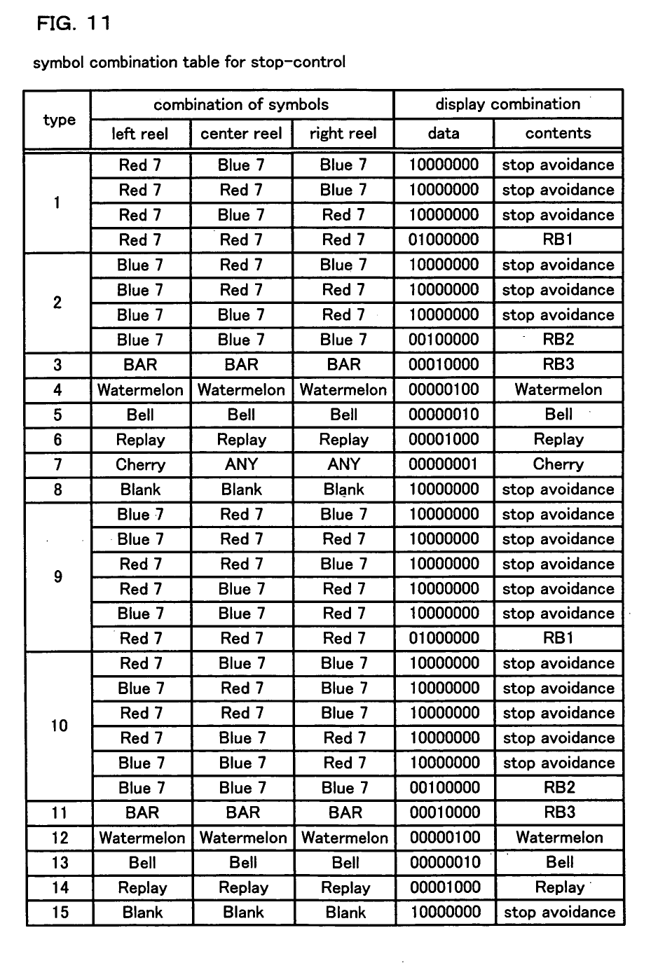

In the followings, a symbol combination table for stop-control is described with reference to FIG. 11.

The symbol combination table for stop-control defines types of combinations of symbols which are retrieved in accordance with the types 1 to 15 and types of display combinations corresponding. In the symbol combination table for stop-control, since it is retrieved the display combination for each of the types 1 to 15, it is possible to reduce the number of retrievals and to rapidly carry out the process, as compared to a symbol combination table which will be described later.

The display combination is expressed by 1 byte data, as the data representing the internal winning combination. For example, the data representing RB1 is expressed by ┌01000000┘.In addition, stop avoidance is defined as a display combination in the symbol combination table for stop-control, so that the data is expressed by ┌10000000┘. When the stop avoidance is determined, it is avoided that a symbol combination corresponding to the stop avoidance is displayed on the activated line. For example, in the type corresponding to Red 7 or Blue 7, in case of a symbol combination in which of three Red 7 and Blue 7 are arranged such as ┌Red 7-Blue 7-Blue 7┘, the stop avoidance is determined as the display combination.

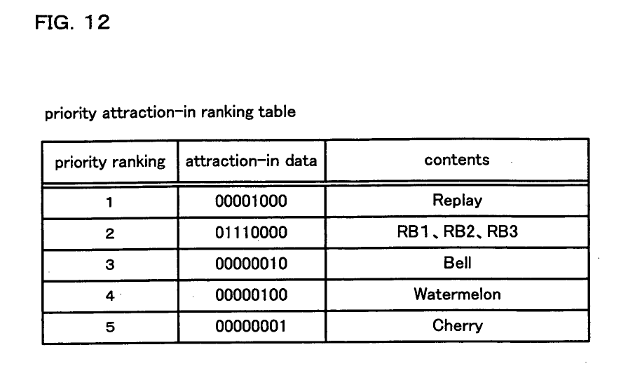

In the followings, a priority attraction-in ranking table is described with reference to FIG. 12.

In the gaming machine 1, it is carried out the control for stopping the rotation of reels 3L, 3C, 3R within 190 msec after the signal is outputted by the stop switch 7S, and the number of sliding symbols is set to be maximum 4 symbols.

The number of sliding symbols is the number of symbols passing to the center line 8c, from after the stop operation is detected through the stop switch 7S until the rotation of the corresponding reel is stopped. It is perceived by a value of the symbol counter updated from after the stop operation is detected through the stop switch 7S.

For example, in case that the number of sliding symbols determined is 4 symbols, when the push operation for right stop button 7R is detected by the stop switch 7S and the symbol counter of the right reel 3R is ┌0┘ at that time, the rotation of the right reel 3R is stopped when the symbol counter is updated to ┌4┘. Thereby, it is possible to stop the rotation of the right reel 3R so that Watermelon (symbol 64) of the symbol position ┌4┘ is displayed on the center line 8c when Red 7 (symbol 61) of the symbol position ┌0┘ is located on the center line 8c.

Like this, the control for stopping the rotation of reel is referred to as ┌attraction-in┘, which allows the symbol within a range of the maximum number of sliding symbols to be displayed at a symbol position (i.e., symbol position from which the reel starts to stop, and referred to as ┌stop starting positions┘) corresponding to the symbol counter of the reel at the time when the stop operation for the reel is detected by the stop switch 7S. In addition, a position of the symbol which is attracted-in as the number of sliding symbols from the stop starting position and then stopped is referred to as ┌expected stop positions┘.

In the priority attraction-in ranking table, it is defined the attraction-in data in relation with each of priority rankings. The priority ranking defines rankings in which the attraction-in is preferentially carried out between the types of the internal winning combination (or types of symbol). The priority rankings 1 to 5 are defined in correspondence with the types of the internal winning combination. Specifically, it is defined the attraction-in data representing ┌Replay 1┘, ┌RB1, RB2 or RB3┘, ┌Bell┘, ┌Watermelon┘, and ┌Cherry┘ in order of the priority rankings 1 to 5. Thereby, in case that two or more types of internal winning combinations are determined, it is determined which type of internal winning combination will have priority.

Herein, RB1, RB2 and RB3 are grouped to have the same priority ranking. Thereby, it is possible to reduce the types of priority ranking and to decrease the data capacity, as compared to a case where the priority ranking is respectively defined in each of RB1, RB2 and RB3.

In addition, the priority attraction-in ranking defines the priority rankings in order of higher privileges which are awarded to the player, except ┌Replay┘. In other words, the priority rankings are defined in order of ┌RB1, RB2 or RB3┘ allowing RB to be operated, Bell having the payout number of 10 pieces, Watermelon having the payout number of 8 pieces and Cherry having the payout number of 4 pieces. Accordingly, the table is structured to consider the payouts to be awarded to the player. In the mean time, the priority rankings defined between the types of the internal winning combination may be arbitrarily changed.

The attraction-in data is expressed by 1 byte data, likewise the data representing the internal winning combination or the data representing the display combination. For example, the data representing Cherry is expressed by ┌00000001┘. In the mean time, the attraction-in data representing ┌RB1, RB2 or RB3┘ is expressed by ┌01110000┘ in which the bit strings corresponding to each RB are ON.

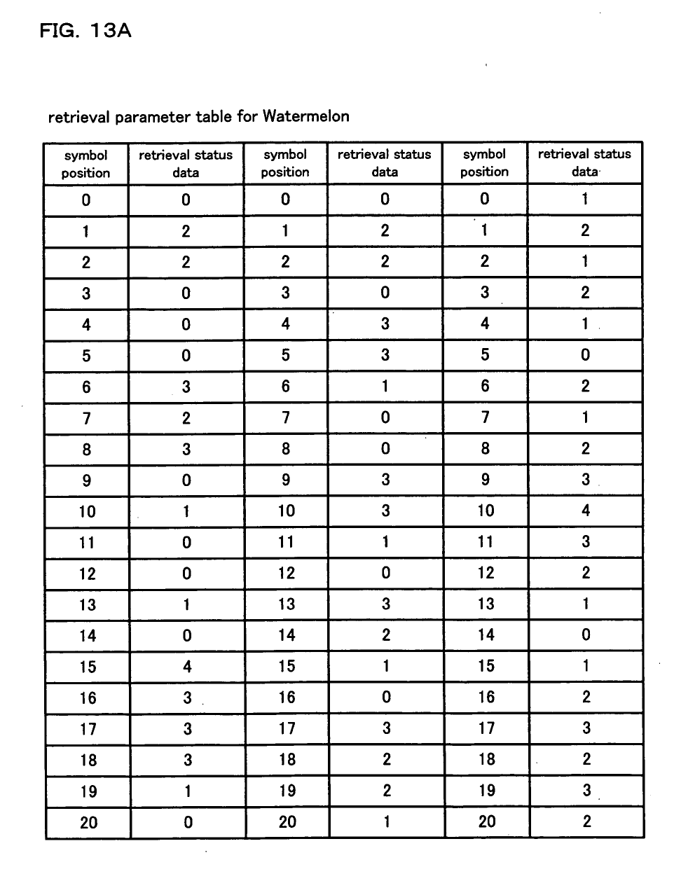

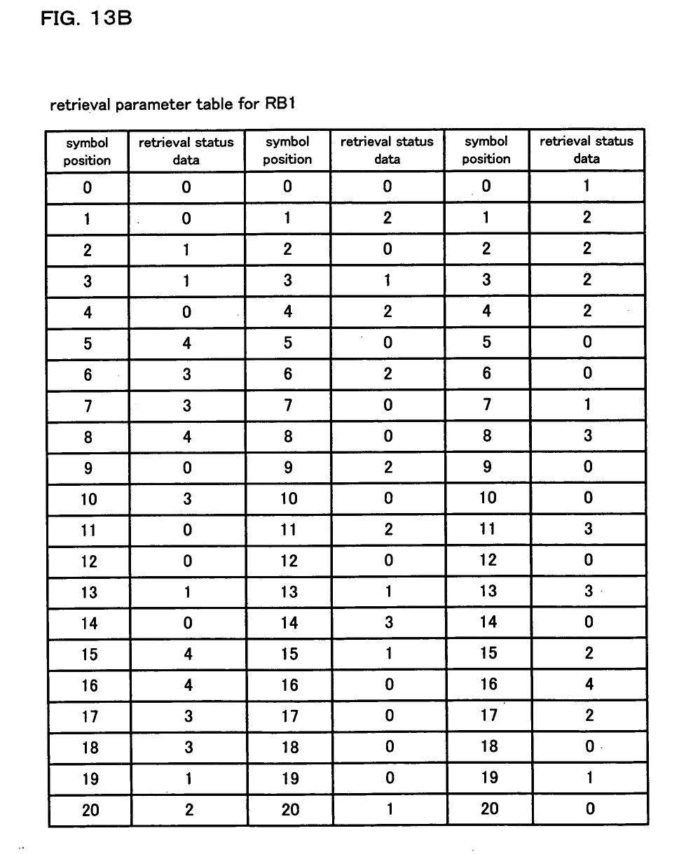

In the followings, a retrieval parameter table is described with reference to FIG. 13. FIG. 13A shows a retrieval parameter table for Watermelon. FIG. 13B shows a retrieval parameter table for RB1.

The retrieval parameter table defines retrieval status data in relation to the symbol position (i.e., stop starting position) of the respective reels 3L, 3C, 3R. The retrieval status data is referred to when it is determined a type of a retrieval order table which will be described later, and is defined with any one of 0 to 4 depending on the symbol positions ┌0┘˜┌20┘.

As shown in FIGS. 13A and 13B, the retrieval parameter table is structured in such a way that the different retrieval status data (for example, ┌0┘ and ┌4┘) are determined depending on the type of the internal winning combination even at the same stop starting position (for example, ┌5┘). Accordingly, the player can suppose the determined internal winning combination by carrying out the stop operation at a timing allowing for the same stop starting position and observing the type of the symbol displayed in the corresponding display window.

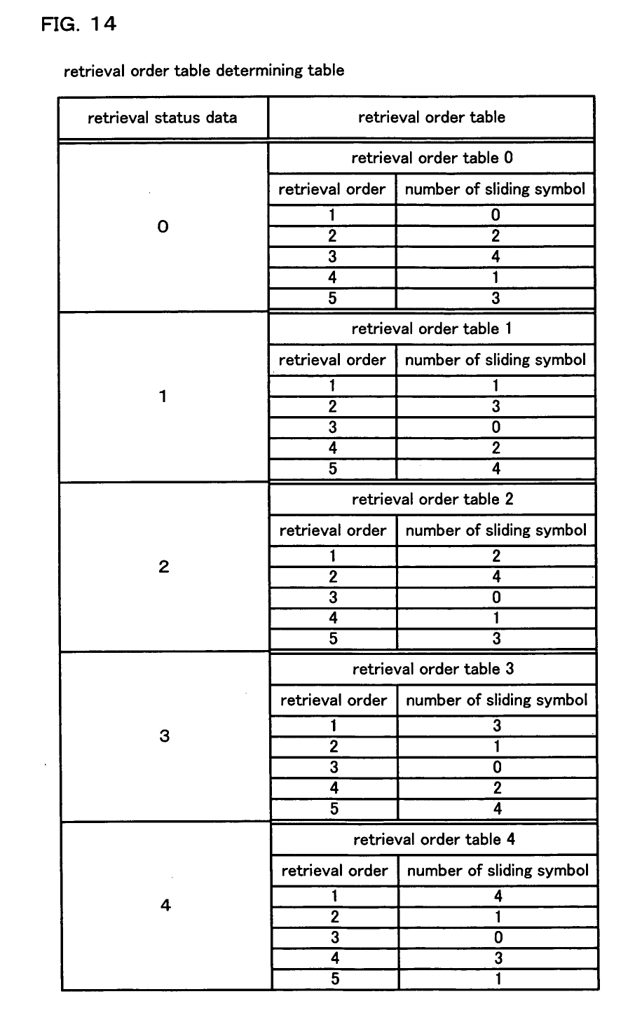

In the followings, a retrieval order table determining table is described with reference to FIG. 14.

The retrieval order table determining table defines types of retrieval order table in relation to the retrieval status data. Specifically, the retrieval order tables 0 to 4 are respectively defined in correspondence with the retrieval status data 0 to 4.

The retrieval order table defines the number of sliding symbols depending on the retrieval order. The retrieval order is an order for carrying out a retrieval for the number of sliding symbols 0 to 4 and is defined with 1 to 5. In addition, each of the retrieval order tables defines the retrieval orders different from each other with regard to the number of sliding symbols 0 to 4. In the mean time, the retrieval order tables 0 to 4 may consist of a single table.

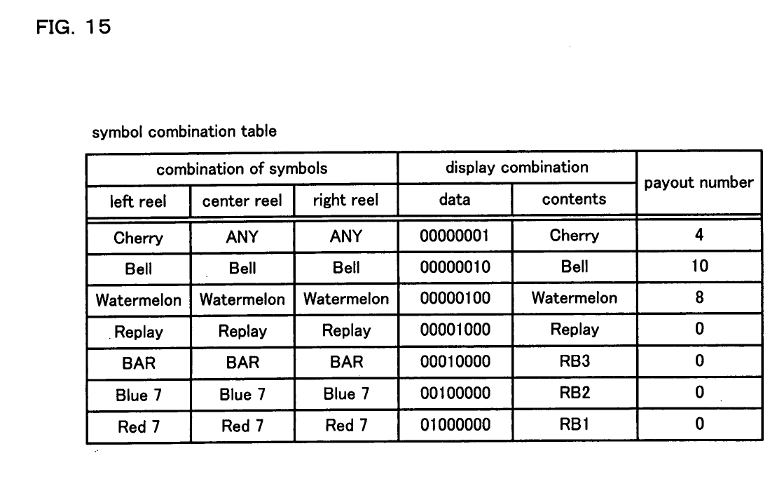

In the followings, a symbol combination table is described with reference to FIG. 15.

The symbol combination table defines a combination of symbols relating to the payout of privilege and a display combination and a payout number corresponding to it. The display combination is expressed by 1 byte data, likewise the data representing the internal winning combination. For example, the data representing BB1 is expressed by ┌01000000┘.

If Cherry (symbol 67) is displayed in any one of the upper, central and lower parts of the left display window 4L, Cherry is determined as an display combination, irrespective of the types of symbols displayed in the other display windows 4C, 4R. In addition, the payout number corresponding to Cherry is 4.

If three Bells (symbol 65) are arranged and displayed along the activated line, Bell is determined as a display combination. In addition, the payout number corresponding to Bell is 10.

If three Watermelons (symbol 64) are arranged and displayed along the activated line, Watermelon is determined as a display combination. In addition, the payout number corresponding to Watermelon is 8.

If three Replays (symbol 66) are arranged and displayed along the activated line, Replay is determined as a display combination. In addition, in case that Replay is determined, a re-game is carried out in a next unit game. In other words, the same number of medals as the insertion number in the unit game in which Replay is determined is automatically inserted in a next game without the insertion operation of the player. Accordingly, the player can play a next unit game without consuming the medals.

If three BARs (symbol 63) are arranged and displayed along the activated line, RB3 is determined as a display combination. In addition, if three Blue 7s (symbol 62) are arranged and displayed along the activated line, RB2 is determined as a display combination. Further, if three Red 7s (symbol 61) are arranged and displayed along the activated line, RB1 is determined as a display combination. In case that RB1, RB2 or RB3 (these can be collectively referred to as ┌RB┘) is determined, a flag under RB operation is updated to ON which will be described later, and thus a RB operation starts.

In addition, if it is displayed a combination of symbols except the combinations of symbols relating to each of Cherry, Bell, Watermelon, Replay, RB3, RB2 and RB1, Losing is determined as a display combination. Herein, Cherry, Bell or Watermelon relates to the payout of the game medium (for example, medal). In addition, Replay relates to an operation of a re-game. Further, RB3, RB2 or RB1 relates to an operation of a gaming state (for example, RB gaming state) advantageous to the player.

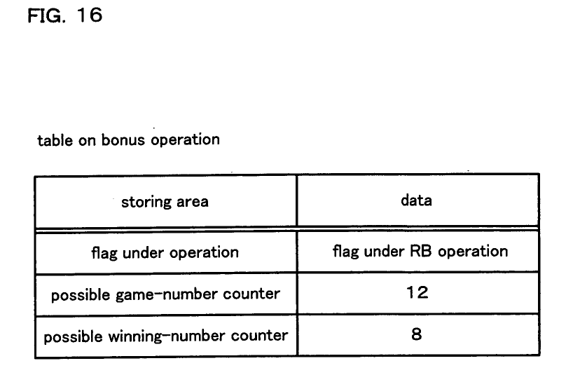

In the followings, a table on bonus operation is described with reference to FIG. 16.

The table on bonus operation defines data stored in a predetermined area of the RAM 33. When RB operates, the flag under RB operation of the RAM 33 becomes ON, 12 is stored in a counter for counting possible games (possible game-number counter) and 8 is stored in a counter for counting possible winnings (possible winning-number counter). The possible game-number counter is data for counting the number of games which are carried out under the RB operation and a one value is subtracted every unit game. The possible winning-number counter is data for counting the number of cases where a winning is determined under RB operation, and a one value is subtracted when a display combination is related to the payout of medals. When the possible game-number counter or possible winning-number counter is updated to 0, the operation of RB is ended.

In the followings, it is described an internal winning combination storing area of the RAM 33 of the main control circuit 71, with reference to FIG. 17.

If an internal winning combination is determined by the internal winning combination determining table, it is stored (memorized) in an internal winning combination storing area. The internal winning combination storing area consists of 1 byte and corresponds to the data of the internal winning combination described above. In other words, the bit string corresponding to the type of the determined internal winning combination becomes ON. Meanwhile, in case of Losing, all bits become 0. Additionally, in case that two or more types of internal winning combinations are determined, the bit corresponding to each type becomes ON. For example, in case that Watermelon and RB1 are determined, the internal winning combination storing area becomes ┌01000100┘.

In the mean time, in case that a display combination is determined by the symbol combination table for stop-control or symbol combination table, the data thereof is stored in a display combination storing area of the RAM 33. The display combination storing area has the same data structure as that of the internal winning combination storing area.

In the followings, it is described an internal carryover combination storing area of the RAM 33 of the main control circuit 71, with reference to FIG. 18.

If RB1, RB2 or RB3 is determined as an internal winning combination by the internal winning combination determining table, it is stored in an internal carryover combination storing area. The internal carryover combination storing area consists of 1 byte in which RB3, RB2 and RB1 correspond to the bits 4, 5 and 6, respectively. When the RB operation starts, the data of the internal carryover combination storing area is cleared. In other words, in the gaming machine 1, if RB is determined as an internal winning combination, the data thereof is stored during a period of until the combination of symbols relating to RB is displayed and the RB operation starts (which is refereed to as carryover). In the mean time, since the internal carryover combination is determined on the basis of the internal winning combination, it can be said that the internal carryover combination is a subordinate concept of the internal winning combination.

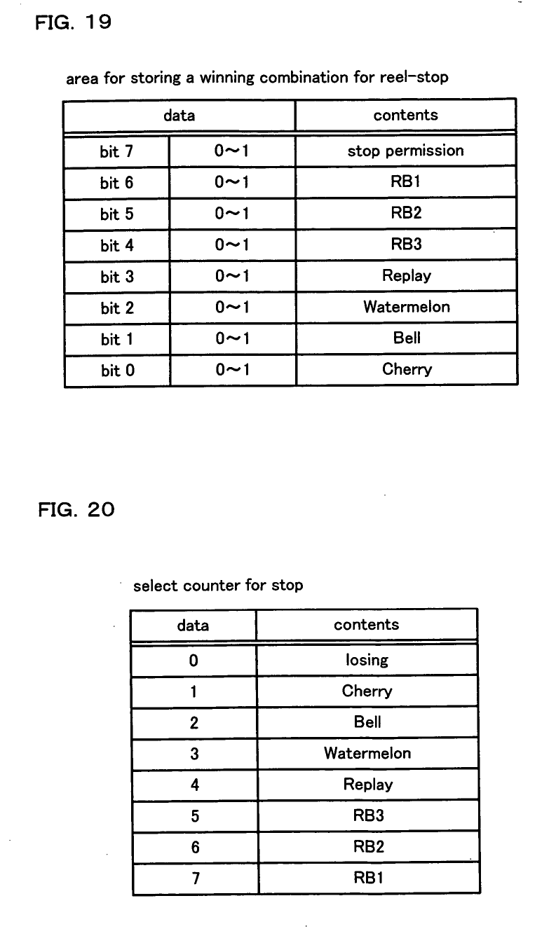

In the followings, it is described an area for storing a winning combination for reel-stop of the RAM 33 of the main control circuit 71, with reference to FIG. 19.

When the data is stored in the internal winning combination storing area, the stored data is copied to an area for storing a winning combination for reel-stop. The area for storing a winning combination for reel-stop consists of 1 byte and has the same data structure as the internal winning combination storing area. However, only bit 7 is different and corresponds to a stop permission. Basically, the stop permission becomes ON when it is allowed a display of a combination of symbols (see FIG. 11) relating to the stop avoidance. In the mean time, the winning combination for reel-stop is data used to carry out the stop control of the rotation of reel, and it can be said that the winning combination for reel-stop is a subordinate concept of the internal winning combination because it is determined on the basis of the internal winning combination.

Herein, the copying of the data of the internal winning combination storing area into the area for storing a winning combination for reel-stop is for carrying out the update of the data copied into the area for storing a winning combination for reel-stop in a process which will be described later. Through the copying, it is prevent a bad effect from occurring, such as so-called erroneous winning resulting from a direct update of the data of the internal winning combination storing area.

Next, it is described a select counter for stop of the RAM 33 of the main control circuit 71, with reference to FIG. 20.

The values of 0˜7 are stored in a select counter for stop. In the mean time, when the winning numbers 0 to 7 are determined, they are stored in a winning number storing area of the RAM 33 which has the same data structure as the select counter.

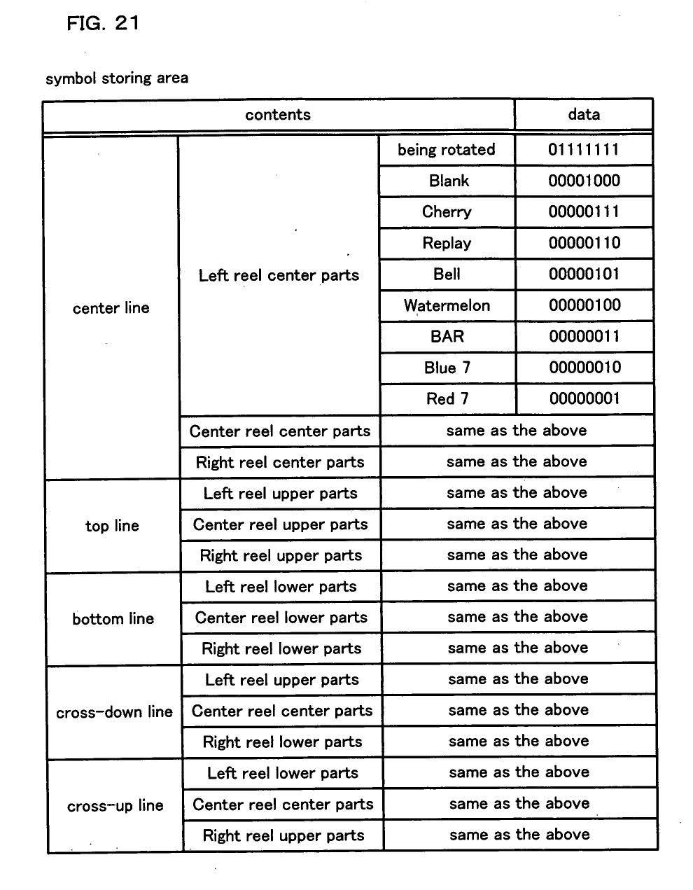

In the followings, it is described a symbol storing area of the RAM 33 of the main control circuit 71 with reference to FIG. 21.

The data representing types of the symbols displayed in the respective display windows 4L, 4C, 4R is stored in a symbol storing area, based on the symbol position (or symbol counter). The symbol storing areas are provided in correspondence with the five activated lines 8a to 8e.

For example, a type of a symbol located in the central part of the left display window 4L, a type of a symbol located in the central part of the center display window 4C and a type of a symbol located in the central part of the right display window 4R are respectively stored in the symbol storing areas corresponding to the center line 8c.

The data stored in each of the symbol storing areas consists of 1 byte and corresponds to the data representing the type of the symbol defined in the symbol arrangement table described above. For example, the data representing Red 7 is ┌00000001┘. In addition, the data representing that the reel is being rotated may be stored in the symbol storing area, which data is expressed by ┌01111111┘.

Herein, in case that an expectation of the display combination is carried out every symbol position of the retrieval target reel, a type of symbol is specified which is displayed in the corresponding display window, based on the symbol positions ┌0┘˜┌20┘ of the retrieval target reel in succession, and then stored in the corresponding symbol storing area.

For example, if the retrieval target reel is the left reel 3L and a position of a retrieval target symbol is ┌0┘, a type of a symbol of the symbol position ┌0┘ and types of symbols located at symbol positions (i.e., symbol position ┌1┘ over one and symbol position ┌20┘ under one) adjacent to the symbol position ┌0┘ are specified on the basis of the symbol arrangement table. Accordingly, Bell of the symbol position ┌1┘ with regard to the upper part of the left reel 3L, Red 7 of the symbol position ┌0┘ with regard to the center part thereof and Watermelon of the symbol position ┌20┘ with regard to the lower part thereof are respectively stored in the symbol storing areas.

In addition, whenever the respective reels 3L, 3C, 3R are stopped, a type of a symbol displayed in the display window is specified on the basis of the symbol counter corresponding to the stopped reel and then stored in the corresponding symbol storing area. In addition, when the rotation of the reel is stopped, a symbol of the symbol position corresponding to the symbol counter of the corresponding reel is displayed at the center line 8c.

For example, when the stopped reel is the left reel 3L and the symbol counter of the left reel 3L is ┌19┘, a type of a symbol of the symbol position ┌19┘ and types of symbols located at the symbol positions (i.e., symbol position ┌20┘ over one and symbol position ┌18┘ under one) adjacent to the symbol position ┌19┘ are specified on the basis of the symbol arrangement table. Accordingly, Watermelon of the symbol position ┌20┘ with regard to the upper part of the left reel 3L, Replay of the symbol position ┌19┘ with regard to the center part thereof and Bell of the symbol position ┌18┘ with regard to the lower part thereof are stored in the symbol storing areas.

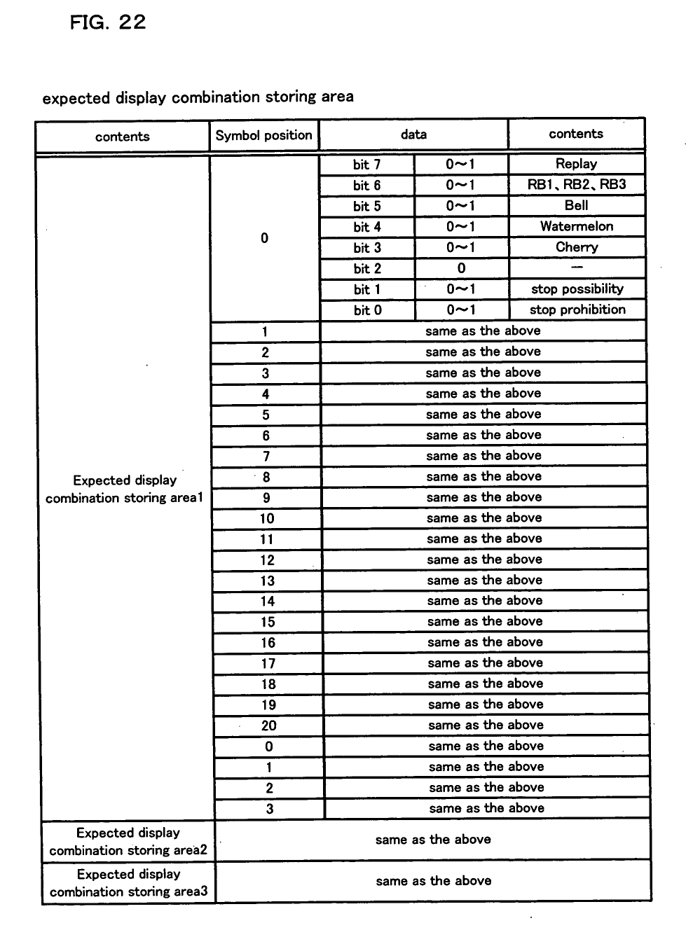

In the followings, it is described an expected display combination storing area of the RAM 33 of the main control circuit 71 with reference to FIG. 22.

An expected display combination storing area stores the priority attraction-in ranking data determined in accordance with each of the symbol positions ┌0┘˜┌20┘ of the retrieval target reel. In the mean time, the expected display combination storing area constitutes a part of priority attraction-in ranking memorizing means.

The priority attraction-in ranking data consists of 1 byte, the bit 0 thereof corresponds to the stop avoidance, the bit 1 corresponds to a stop possibility, the bit 3 corresponds to Cherry, the bit 4 corresponds to Watermelon, the bit 5 corresponds to Bell, the bit 6 corresponds to ┌RB1, RB2, RB3┘, and the bit 7 corresponds to Replay. In addition, when all the bits are 0, it is under stop prohibition.

Like this, in the priority attraction-in ranking data, the greater the value (the upper bit is ON (i.e., 1)), the higher the priority attraction-in ranking. Accordingly, by referring to the priority attraction-in ranking data relating to each symbol position, it is possible to relatively evaluate the priority attraction-in ranking between the symbols arranged on the periphery of the reel. In addition, the symbol position determined to have the greatest value as the priority attraction-in ranking data becomes the symbol having the highest priority attraction-in ranking. In the mean time, the priority attraction-in ranking data is an example of the priority attraction-in ranking.

In addition, in the expected display combination storing area, RB1, RB2 and RB3 are grouped to allot one bit string (i.e., bit 6). Thereby, since it is possible to reduce the values taken as the priority attraction-in ranking data, as compared to a case where one bit string is allotted to each of RB1, RB2 and RB3, the increase of data capacity can be prevented to the utmost.

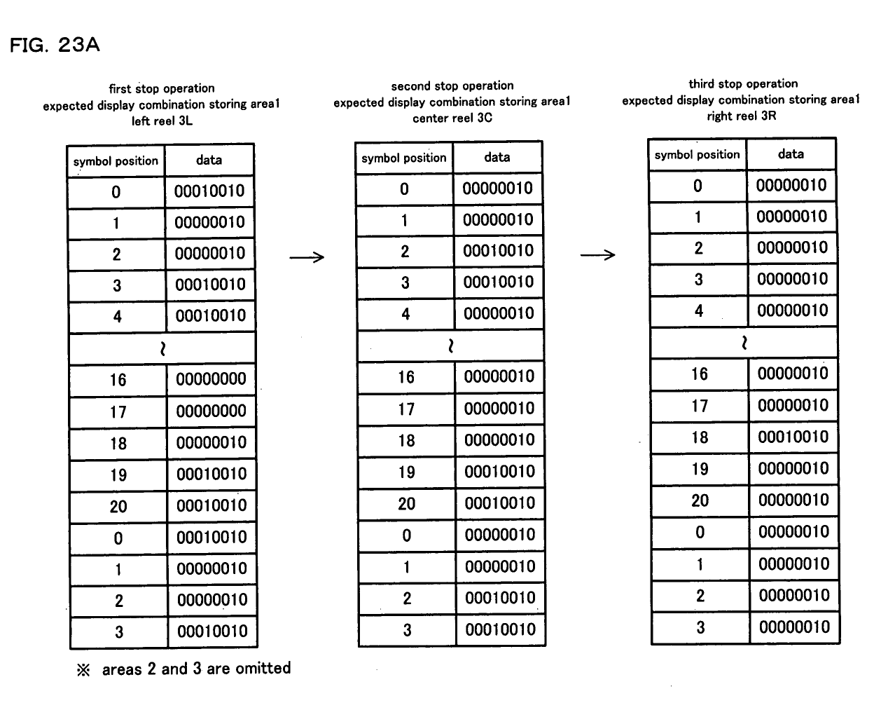

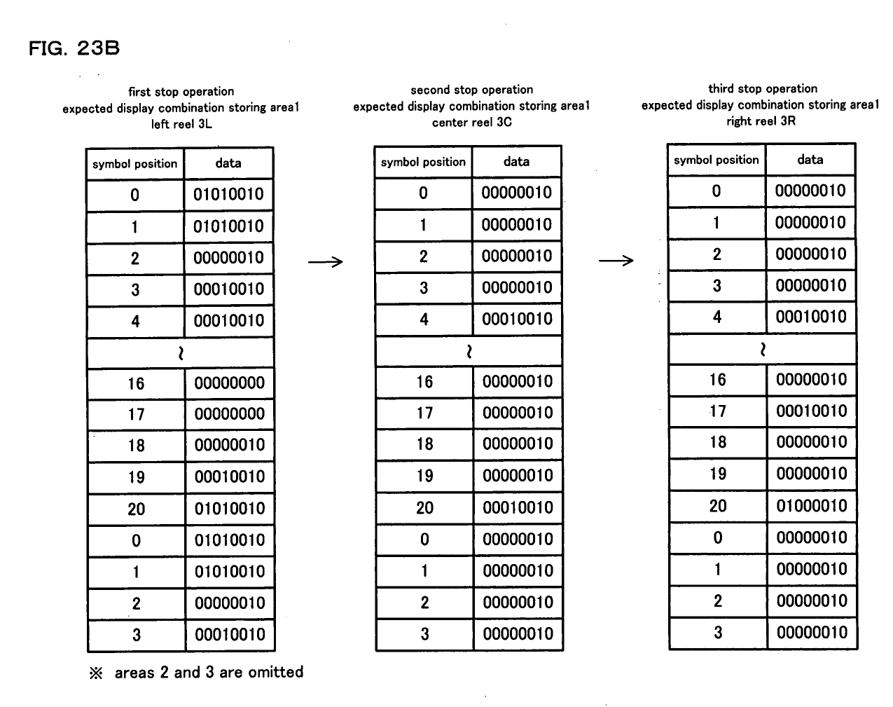

Hereinafter, a storing example of an expected display combination storing area is described with reference to FIG. 23.

FIG. 23A is a storing example of an expected display combination storing area 1, in case that the data ┌00000100┘ is stored in the internal winning combination storing area. In the mean time, although the priority attraction-in ranking data is also stored regarding the respective symbol positions of an expected display combination storing area 2 and the respective symbol positions of an expected display combination storing area 3, a storing example thereof is omitted in FIG. 23.

In the storing example shown in FIG. 23A, for example, referring to the first stop operation carried out for the left stop reel 3L, among the respective positions of the left reel 3L, it is highest the value of the priority attraction-in ranking data of the symbol position (for example, ┌0┘, ┌3┘, ┌4┘, ┌19┘, ┌20┘) at which Watermelon, which is a symbol relating to an internal winning combination, is displayed in the left display window 4L.

FIG. 23B is a storing example of an expected display combination storing area 1, in case that the data ┌01000100┘ is stored in the internal winning combination storing area. In the mean time, although the priority attraction-in ranking data is also stored regarding the respective symbol positions of an expected display combination storing area 2 and the respective symbol positions of an expected display combination storing area 3, a storing example thereof is omitted in FIG. 23.

In the storing example shown in FIG. 23B, for example, referring to the first stop operation carried out for the left stop reel 3L, among the respective positions of the left reel 3L, it is highest the priority attraction-in ranking data of the symbol position (for example, ┌0┘, ┌1┘, ┌20┘) at which Red 7 is displayed in the display window and the priority attraction-in ranking data of the symbol position (for example, ┌3┘, ┌4┘, ┌19┘) at which Watermelon is displayed in the display window is next to it.

Hereinafter, a control carried out by the CPU 31 of the main control circuit 71 is described with reference to flow charts shown in FIGS. 24 to 36.

First, a RESET-intervention process is described with reference to FIG. 24, which is executed by the CPU 31 of the main control circuit 71. When power is inputted and a voltage is applied to a reset terminal, the CPU 31 generates a RESET-intervention and sequentially carries out a RESET-intervention process which is stored in the ROM 32, on the basis of the generation of the RESET-intervention.

When the power is inputted, the CPU 31 first executes an initialization process (step S1). In the initialization process, it is carried out a process of restoring an execution address or register data stored in the RAM 33 when the power is cut off.

Next, the CPU 31 clears an indicated storing area (step S2). Thereby, the data stored in the internal winning combination storing area, etc. of the RAM 33 is cleared.

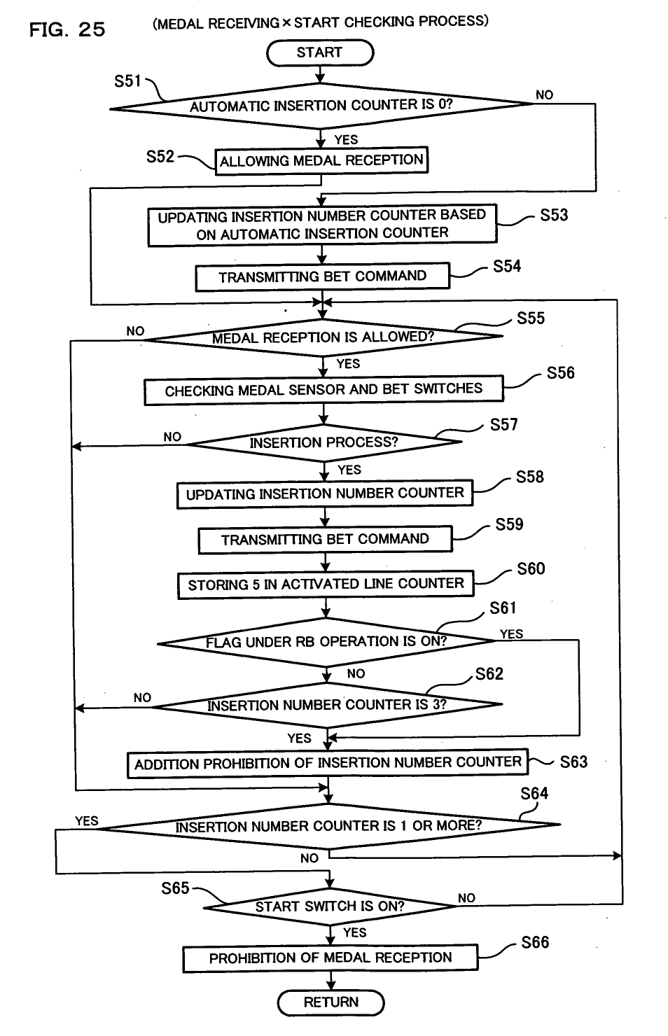

Next, the CPU 31 executes a medal receiving×start checking process which will be described later with reference to FIG. 25 (step S3). In the medal receiving×start checking process, the insertion number counter is updated through the check on the medal sensor 22S, the BET switches 11S, 12S, 13S and the like, or the input of the start switch 6S is checked.

Next, the CPU 31 samples and stores a random number value in the random number value storing area (step S4). Specifically, the CPU 31 samples a random number value for lottery by the random number generator 36 and the sampling circuit 37, which is used in the internal lottery process and the like, and stores it in the random number value storing area of the RAM 33.

Next, the CPU 31 executes a gaming status supervisory process (step S5). Specifically, the CPU stores an identifier (so-called flag) representing the RB gaming state in the RAM 33 if the flag under RB operation is ON and stores an identifier representing the normal gaming state in the RAM 33 if the flag under RB operation is OFF.

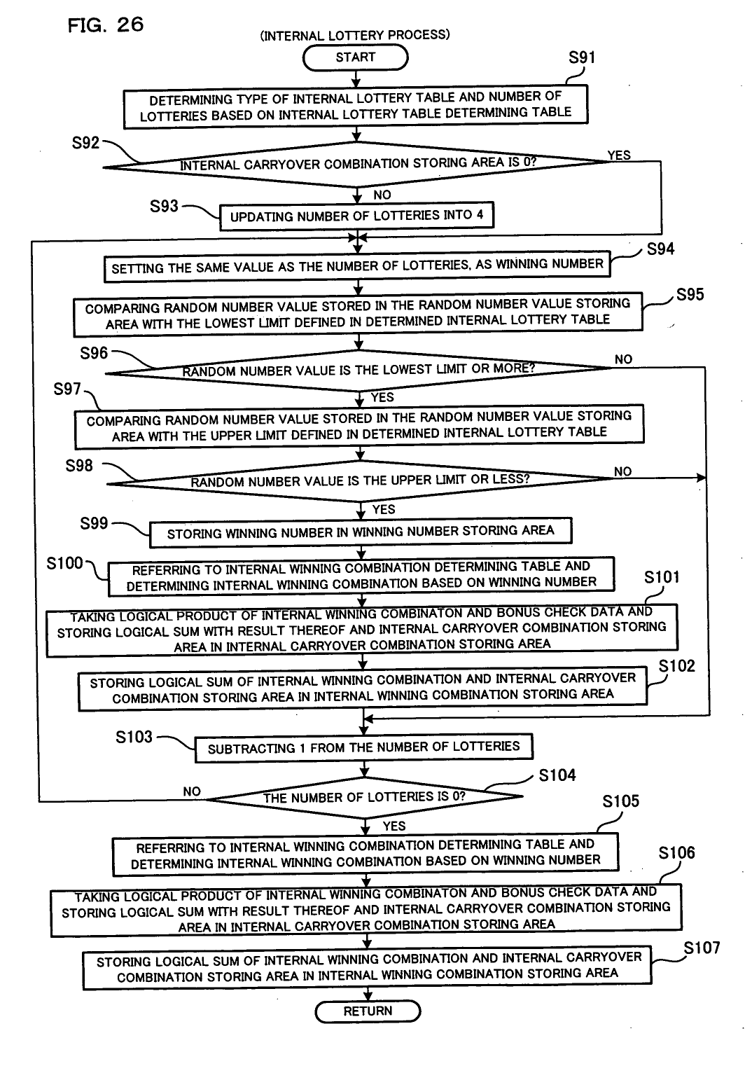

Next, the CPU 31 performs an internal lottery process which will be described later with reference to FIG. 26 (step S6). In the internal lottery process, it is carried out a process of determining an internal winning combination and the like. In the mean time, the internal lottery process constitutes a part of the internal winning combination determining means.

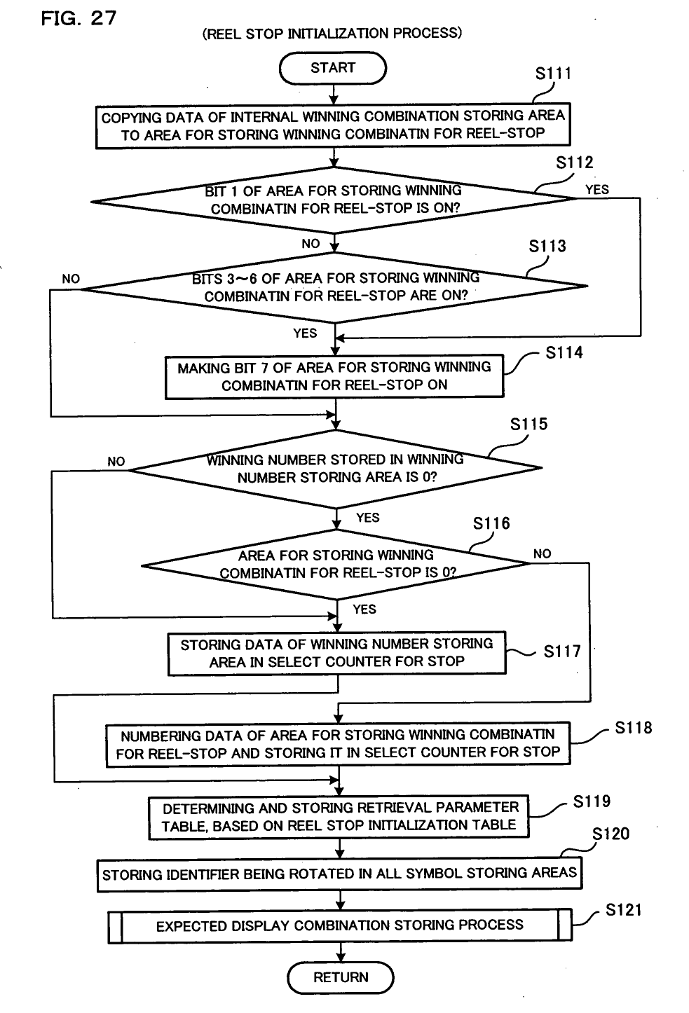

Next, the CPU 31 carries out a reel stop initialization process which will be described later with reference to FIG. 27 (step S7). In the reel stop initialization process, it is performed a process of determining a retrieval parameter table.

Next, the CPU 31 transmits the start command to the sub-control circuit 72 (step S8). The start command contains data such as internal winning combination, gaming state and the like.

Next, the CPU 31 determines whether 4.1 seconds have elapsed after a previous reel has started to rotate (step S9). When it is determined that 4.1 seconds have not elapsed, the CPU 31 consumes the waiting time (step S10). Specifically, the CPU 31 carries out a waiting process without performing the subsequent processes until 4.1 seconds have elapsed.

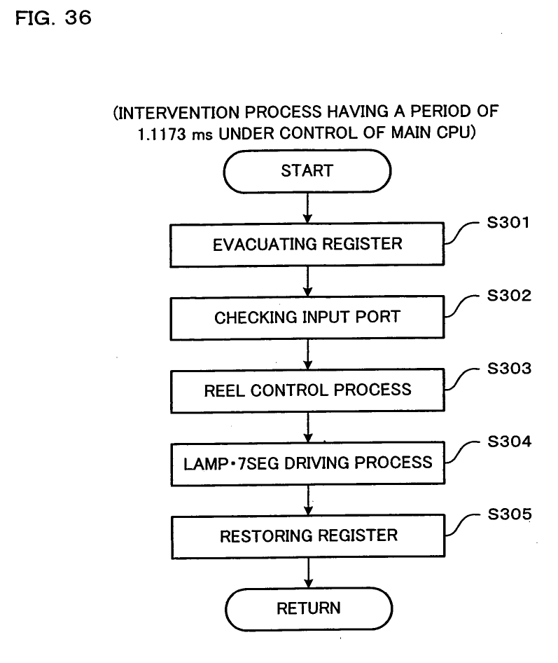

When it is determined that 4.1 seconds have elapsed, or after the process in the step S10, the CPU 31 requests rotation start of all the reels (step S11) by updating a predetermined identifier, for example. When it is requested the rotation of all the reels, a process of starting to rotate the reels is carried out in an intervention process (see FIG. 36) which will be described later.

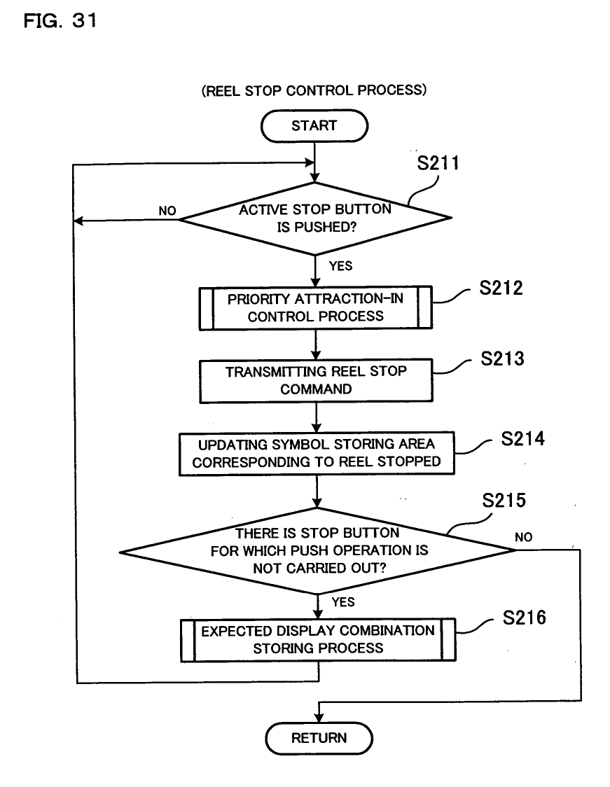

Next, the CPU 31 executes a reel stop control process which will be described later with reference to FIG. 31 (step S12). In the reel stop control process, it is carried out a process of stopping the rotation of the reel 3L, 3C, 3R.

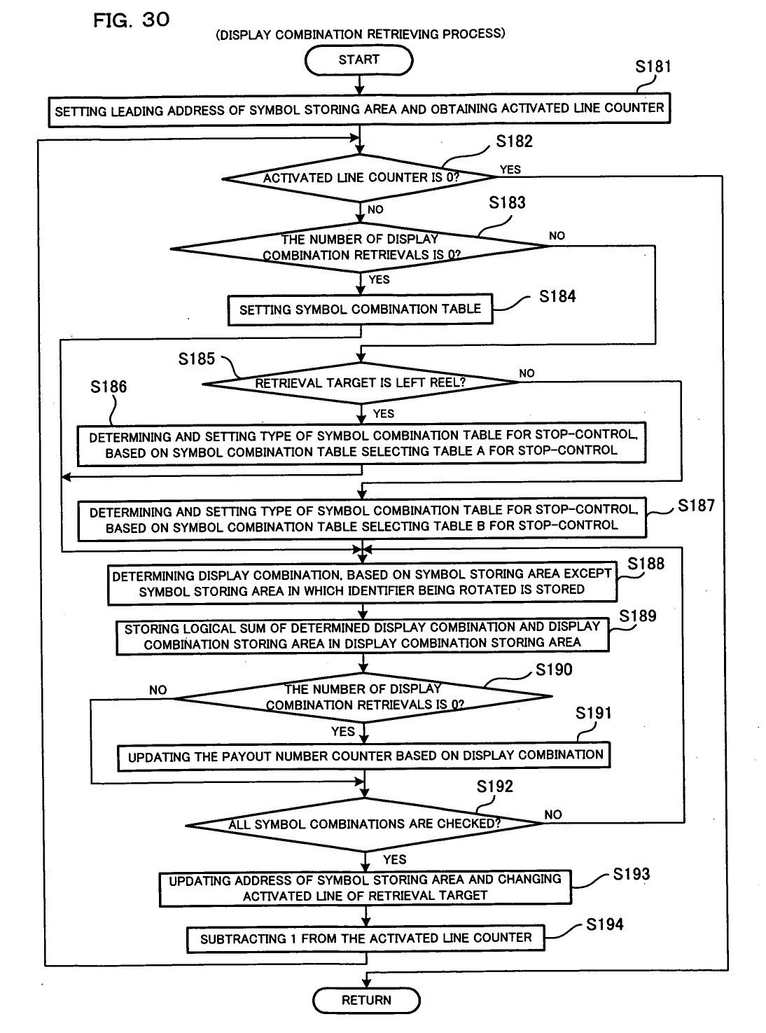

Next, the CPU 31 carries out a display combination retrieving process which will be described later with reference to FIG. 30 (step S13). In this display combination retrieving process, it is referred to the data stored in the symbol storing area and it is carried out a process of determining a type of a display combination and a payout number for each of the activated lines, based on the symbol combination table.

Next, the CPU 31 transmits a display combination command to the sub-control circuit 72 (step S14). The display combination command contains data such as display combination made and the like.

Next, the CPU 31 carries out a medal payout process (step S15). Specifically, the CPU 31 controls the hopper 40 or updates the credit counter, based on the payout number determined in the step S13.

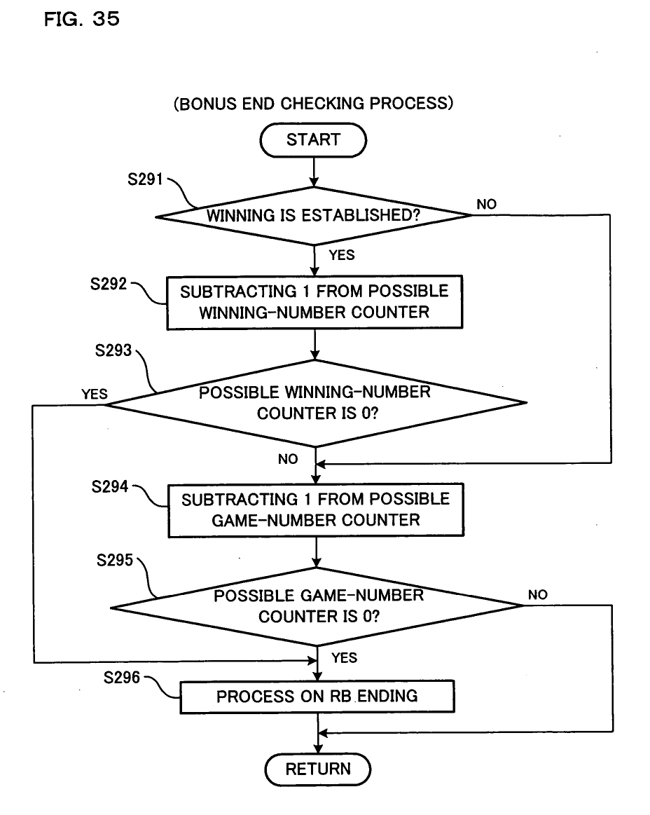

Next, the CPU 31 determines whether the flag under RB operation is ON or not (step S16). If it is determined that the flag under RB operation is ON, the CPU 31 carries out a bonus end checking process which will be described later with reference to FIG. 35 (step S17). In the bonus end checking process, it is carried out a process of ending the RB operation, based on the update result of the possible winning-number counter or possible game-number counter.

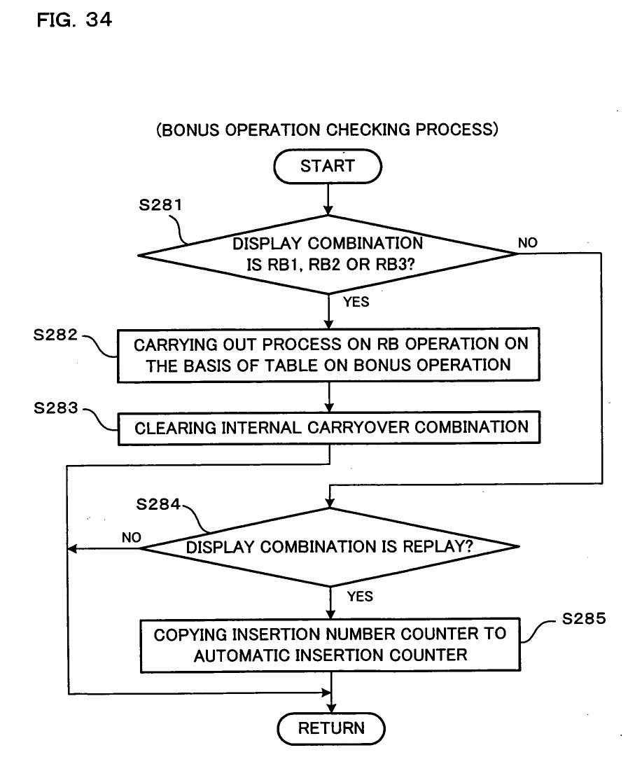

When it is determined that the flag under RB operation is not ON in the step of S16, or after the process in the step S17, the CPU 31 carries out a bonus operation checking process which will be described with reference to FIG. 34 (step S18). In the bonus operation checking process, it is carried out a process of starting an operation of RB when a display combination is one of RB1, RB2 and RB3.

Like this, the CPU 31 executes the steps S2 to S18 as processes in a unit game. When the step S18 is over, the CPU proceeds to the step S2 so as to carry out the processes in a next unit game.

In the followings, a medal receiving×start checking process is described with reference to FIG. 25.

First, the CPU 31 determines whether an automatic insertion counter is 0 or not (step S51). When it is determined that the automatic insertion counter is 0, the CPU 31 allows the reception of medal (step S52) by the update of a predetermined identifier, for example. The automatic insertion counter is data for discriminating whether Replay has been determined in the previous unit game.

When it is determined that the automatic insertion number is not 0 in the step S51, the CPU 31 updates an insertion number counter, based on the automatic insertion counter (step S53). The insertion number counter is data for counting the insertion number.

Next, the CPU 31 transmits a BET command to the sub-control circuit 72 (step S54). The BET command includes data of the insertion number and the like.

After the process in the step S54 or the process in the step S52, the CPU 51 determines whether the reception of medal is allowed or not (step S55). When it is determined that the reception of medal is allowed, the CPU 31 checks the medal sensor 22S and the BET switches 11S, 12S, 13S (step S56).

Next, the CPU 31 determines whether it is under insertion process (step S57). Specifically, the CPU 31 determines that it is under insertion process when the medal sensor 22S or the BET switches 11S, 12S, 13S is ON. In addition, in case that the BET switches 11S, 12S, 13S are ON, the CPU 31 calculates a value to be added to the insertion number counter, based on types of the BET switches 11S, 12S, 13S, the insertion number counter and a credit counter. The credit counter is data for counting the number of medals credited.

When it is determined as the insertion process in the step S57, the CPU 31 updates the insertion number counter (step S58). Meanwhile, in this process, when it is prohibited the addition of the insertion number counter, the CPU 31 updates the credit counter, instead of the insertion number counter.

Next, the CPU 31 transmits the BET command to the sub-control circuit 72 (step S59). Next, the CPU 31 stores 5 in an activated line counter (step S60). The activated line counter is data for specifying the number of activated lines. In the embodiment, 5 is always stored in the activated line counter, irrespective of the value of the insertion number counter.

Next, the CPU 31 determines whether the flag under RB operation is ON or not (step S61). When it is determined that the flag under RB operation is not ON, the CPU 31 determines whether the insertion number counter is 3 or not (step S62).

When it is determined that the insertion number counter is 3 in the step S62, or when it is determined that the flag under RB operation is ON in the step S61, the CPU prohibits the addition of the insertion number counter by an update of a predetermined flag (step S63).

After the process in the step S63, when it is determined that the reception of medal is not allowed in the step S55, when it is determined that it is not under insertion process in the step S57 or when it is determined that the insertion number counter is not 3 in the step S62, the CPU 31 determines whether the insertion number counter is 1 or more (step S64). If it is determined that the insertion number counter is not 1 or more, the CPU 31 proceeds to the step S55.

When it is determined that the insertion number counter is 1 or more in the step S64, the CPU 31 determines whether the start switch 6S is ON or not (step S65). When it is determined that the start switch 6S is not ON, the CPU 31 proceeds to the step S55.

When it is determined that the start switch 6S is ON in the step S65, the CPU 31 prohibits the reception of medal by an update of a predetermined identifier (step S66). When this process is over, the CPU ends the medal receiving×start checking process and proceeds to the step S4 in FIG. 24.

In the followings, an internal lottery process is described with reference to FIG. 26.

First, the CPU 31 determines a type of the internal lottery table and the number of lotteries, based on the gaming state and the internal lottery table determining table (step S91).

Next, the CPU 31 determines whether the internal carryover combination storing area is 0 or not (i.e., whether there is an internal carryover combination) (step S92). When it is determined that the internal carryover combination storing area is not 0, the CPU 31 changes the number of lotteries into 4 (step S93). In other words, when there is an internal carryover combination in the normal gaming state, the number of lotteries determined to be 7 times is changed to 4 times and RB is not duplicately determined.

When it is determined that the internal carryover combination storing area is 0 in the step S92, or after the process in the step S93, the CPU 31 sets a value same as the number of lotteries, as a winning number (step S94).

Next, the CPU 31 compares the random number value stored in the random number value storing area with the lowest limit defined in the internal lottery table determined (step S95). Then, the CPU 31 determines whether the random number value is the lowest limit or more (step S96).

When it is determined that the random number value is the lowest limit or more, the sub-CPU 81 compares the random number value stored in the random number value storing area with the upper limit defined in the internal lottery table determined (step S97). Then, the CPU 31 determines whether the random number value is the upper limit or less (step S98).

When it is determined that the random number value is the upper limit or less, the CPU 31 stores the set winning number in a winning number storing area of the RAM 33 (step S99). The winning number storing area has an initial value of 0 and is sequentially overwritten as this process is carried out. Accordingly, when the winning numbers are duplicately determined, the smaller winning number is preferentially stored.

Next, the CPU 31 refers to the internal winning combination determining table to determine an internal winning combination based on the winning number stored in the winning number storing area (step S100). Then, the CPU 31 takes a logical product of the determined internal winning combination and bonus check data and stores a logical sum with a result thereof and the internal carryover combination storing area in the internal carryover combination storing area (step S101). The bonus check data is expressed by ┌01110000┘. As a result of this process, in case that the internal winning combination is RB, a carryover of RB is carried out.

Next, the CPU 31 stores a logical sum of the internal winning combination and the internal carryover combination storing area in the internal winning combination storing area (step S102). For example, in case that Bell is determined when RB3 is carried over, the data of the internal winning combination storing area is ┌00010010┘.

After the process in the step S102, when it is determined that the random number value is not the lowest limit or more in the step S96, or when it is determined that the random number value is not the upper limit or less in the step S98, the CPU 31 subtracts 1 from the number of lotteries (step S103).

Next, the CPU 31 determines whether the number of lotteries is 0 or not (i.e., whether the retrieval for all the winning numbers is ended or not) (step S104). When it is determined that the number of lotteries is not 0, the CPU 31 proceeds to the step S94.

When it is determined that the number of lotteries is 0 in the step S104, the CPU 31 refers to the internal winning combination determining table to determine an internal winning combination, based on the winning number (step S105). In this process, in case that the initial value 0 is stored in the winning number storing area, the losing is determined.

Next, the CPU takes a logical product of the determined internal winning combination and the bonus check data (i.e., 01110000), and stores a logical sum with a result thereof and the internal carryover combination storing area in the internal carryover combination storing area (step S106). Then, the CPU 31 stores a logical sum of the internal winning combination and the internal carryover combination storing area in the internal winning combination storing area of the RAM 33 (step S107). When this process is over, the CPU ends the internal lottery process and proceeds to the step S7 in FIG. 24.

In the followings, a reel stop initialization process is described with reference to FIG. 27.

First, the CPU 31 copies the data of the internal winning combination storing area into the area for storing a winning combination for reel-stop (step S111). Next, the CPU 31 determines whether the bit 1 (i.e., Bell) of the area for storing a winning combination for reel-stop is ON or not (step S112).

When it is determined that the bit 1 of the area for storing a winning combination for reel-stop is not ON, the CPU 31 determines whether at least one of the bits 3 to 6 (i.e., Replay, RB3, RB2, RB1) of the area for storing a winning combination for reel-stop is ON or not (step S113).

When it is determined that at least one of the bits 3 to 6 of the area for storing a winning combination for reel-stop is ON in the step S113, or when it is determined that the bit 1 of the area for storing a winning combination for reel-stop is ON in the step S112, the CPU 31 makes the bit 7 (i.e., stop permission) of the area for storing a winning combination for reel-stop ON (step S114). In other words, it is allowed a pattern of the stop permission, in case of only one of Bell, Replay, RB1, RB2 and RB3. The pattern of stop permission is a combination of symbols in which three of Red 7 and Blue 7 are arranged such as ┌Red 7-Blue 7-Blue 7┘. The reason that it is permitted when RB is determined is for using the combination of symbols described above as so-called ┌ready-to-win combinations┘. In addition, the reason that it is permitted when Bell or Replay is determined is as follows: when it is displayed a combination of symbols relating to Bell or Replay, there is a possibility that the combination of symbols described above will be displayed due to the arrangement of symbols.

Next, the CPU 31 determines whether the winning number stored in the winning number storing area is 0 (i.e., losing) (step S115). When it is determined that the winning number stored in the winning number storing area is 0, the CPU 31 determines whether the area for storing a winning combination for reel-stop is 0 or not (i.e., whether there is an internal carryover combination) (step S116).

When it is determined that the area for storing a winning combination for reel-stop is 0 in the step S116, or when it is determined that the winning number is not 0 in the step S115, the CPU 31 stores the data of the winning number storing area in the select counter for stop (step S117). For example, when the data of the winning number storing area is ┌3┘, the CPU stores ┌3┘ in the select counter for stop.

When it is determined that the area for storing a winning combination for reel-stop is not 0 in the step S116, the CPU 31 numbers the data of the area for storing a winning combination for reel-stop and stores it in the select counter for stop (step S118). Specifically, when the bit 4 is ON, the CPU 31 stores 5, when the bit 5 is ON, the CPU stores 6, and when the bit 6 is ON, the CPU stores 7.

After the process in the step S118 or step S117, the CPU 31, based on the select counter for stop stored and the reel stop initialization table, determines and stores a retrieval parameter table in the RAM 33 (step S119).

Next, the CPU 31 stores the identifier being rotated in all the symbol storing areas (step S120). Specifically, the CPU 31 sets all the bits 0 to 6 in all the symbol storing areas to be ┌1┘.

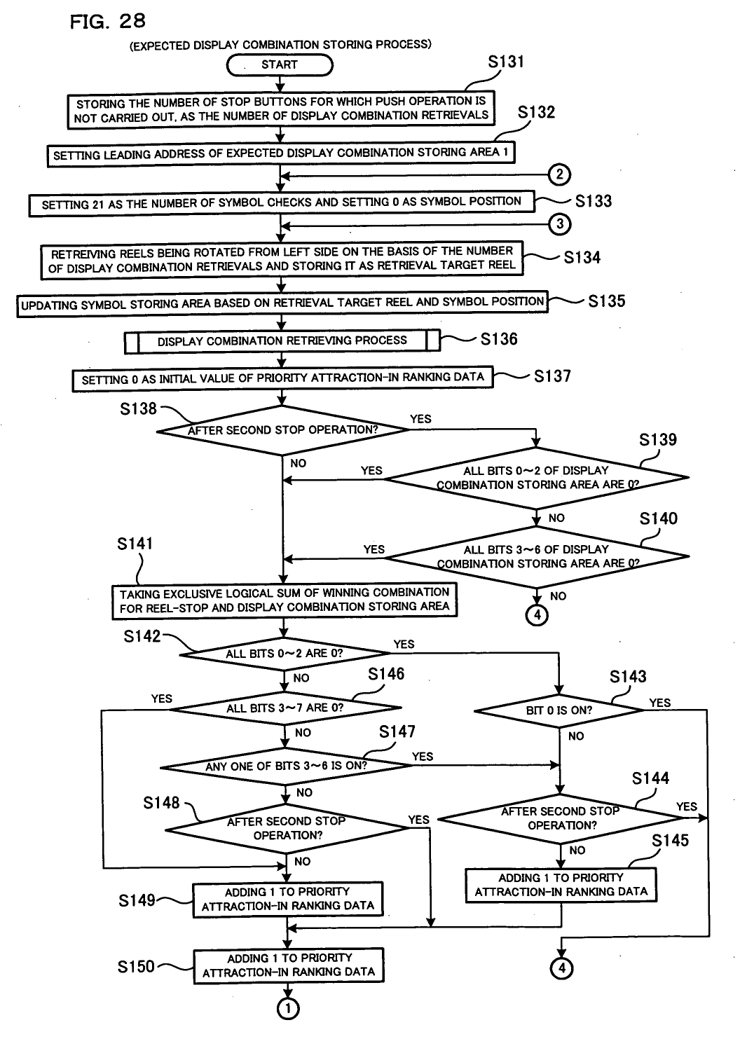

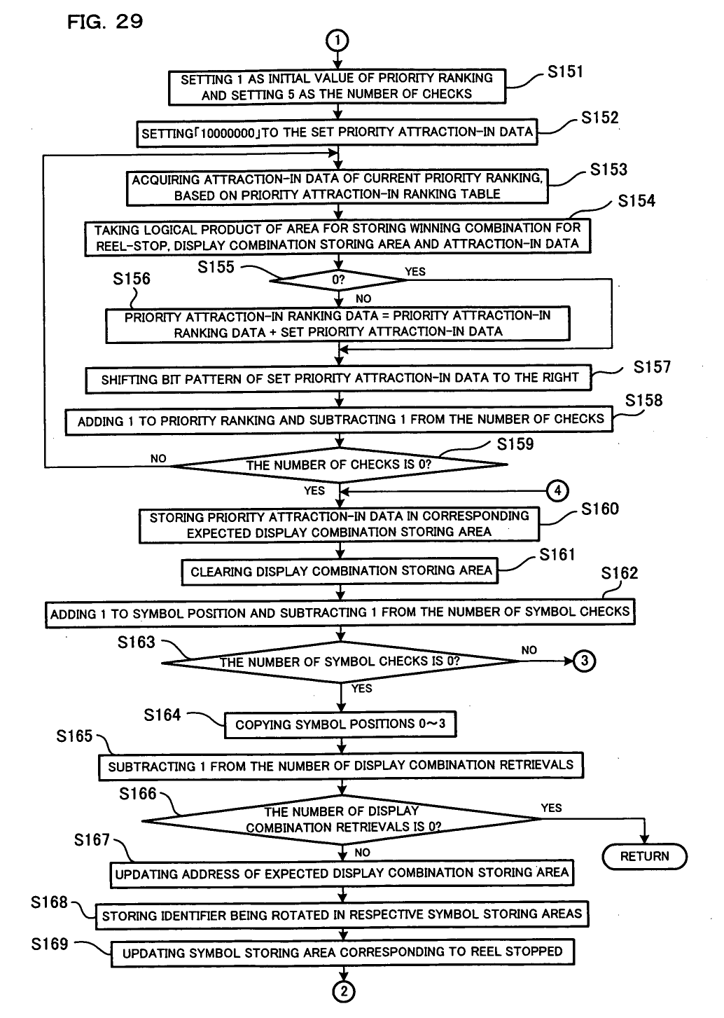

Next, the CPU carries out an expected display combination storing process which will be described with reference to FIGS. 28 and 29 (step S121). In this expected display combination storing process, the CPU carries out an expectation of the display combination in accordance with the symbols of the symbol positions ┌0┘˜┌20┘ in the respective reels 3L, 3C, 3R, before all the reels start to rotate, and determines the priority attraction-in ranking, based on the expected display combination. When this process is over, the CPU ends the reel stop initialization process and proceeds to the step S8 in FIG. 24.

In the followings, an expected display combination storing process is described with reference to FIGS. 28 and 29. In the mean time, the expected display combination storing process constitutes a part of the priority ranking determining means.

First, the CPU 31 stores the number of the stop buttons 7L, 7C, 7R for which the push operation is not carried out in the RAM 33, as the number of display combination retrievals (step S131). In case of the expected display combination storing process called from the step S121 of the reel stop initialization process (see FIG. 27), 3 is stored as the number of the display combination retrievals. In addition, in case of the expected display combination storing process called from a step S215 of a reel stop control process (see FIG. 31) which will be described later, 1 or 2 is stored as the number of display combination retrievals.

Next, the CPU 31 sets a leading address of the expected display combination storing area 1 (step S132). Specifically, a leading address of the symbol position ┌0┘ of the expected display combination storing area 1 is set. Then, the CPU 31 sets ┌21┘ as the number of symbol checks and ┌0┘ as the symbol position (step S133).

Next, the CPU 31 retrieves the reel being rotated from the right side, based on the number of display combination retrievals, and stores it as a retrieval target reel (step S134). Specifically, all the reels being rotated are retrieved, so that the left reel 3L, the center reel 3C and the right reel 3R are sequentially stored as the retrieval target reel, from the reel which is being rotated and nearer at the left side. For example, if the number of display combination retrievals is 3, the left reel 3L is determined first of all.

Next, the CPU 31 updates the symbol storing area, based on the retrieval target reel and the symbol position (step S135). Specifically, based on the retrieval target reel, the symbol position and the symbol arrangement table, a type of the symbol of the corresponding symbol position and types of the symbols of the symbol positions adjacent to the corresponding symbol position are stored in the symbol storing areas.

Next, the CPU 31 carries out a display combination retrieving process which will be described with reference to FIG. 30 (step S136). In the display combination retrieving process, it is referred to the data stored in the symbol storing area, and it is performed a process of expecting a display combination, i.e., retrieving a combination of symbols which can be displayed in the display windows, for each symbol of each symbol position, based on the symbol combination table for stop-control. In the mean time, the display combination retrieving process in the step S136 constitutes a part of symbol combination expectation means.

Next, the CPU 31 sets 0 as an initial value of the priority attraction-in ranking data (step S137). Since the priority attraction-in ranking data is expressed by 1 byte, its initial value is ┌00000000┘.

Next, the CPU 31 determines whether it is after the second stop operation or not (step S138). When it is determined that it is after the second stop operation, the CPU 31 determines whether all the bits 0 to 2 of the display combination storing area are 0 or not (step S139). When it is determined that all the bits 0 to 2 of the display combination storing area are not 0, the CPU 31 determines whether all the bits 3 to 6 of the display combination storing area are 0 or not (step S140). When it is determined that all the bits 3 to 6 of the display combination storing area are not 0, the CPU 31 proceeds to a step S160 which will be described later.

When it is determined that it is not after the second stop operation in the step S138, when it is determined that all the bits 0 to 2 of the display combination storing area are 0 in the step S139, or when it is determined that all the bits 3 to 6 of the display combination storing area are 0 in the step S140, the CPU 31 takes an exclusive logical sum of the winning combination for reel-stop and the display combination storing area, and then takes a logical product of a result thereof and the display combination storing area (step S141). Through the process, it is clarified whether there is a bit which is ON in the display combination storing area only. From this, it is clarified whether the display combination is included in the winning combination for reel-stop, i.e., whether the symbol position at this time satisfies the determined internal winning combination.

Next, the CPU 31 determines whether all the bits 0 to 2 are 0 or not (step S142). When it is determined that all the bits 0 to 2 are not 0, the CPU 31 determines whether the bit 0 is ON or not (step S143). When it is determined that the bit 0 is ON, the CPU 31 proceeds to a process of a step S160 which will be described later.

When it is determined that the bit 0 is not ON in the step S143, the CPU 31 determines whether it is after the second stop operation (step S144). When it is determined that it is after the second stop operation, the CPU 31 proceeds to a step of S160 which will be described later.

When it is determined that it is not after the second stop operation in the step S144, the CPU 31 adds 1 to the priority attraction-in ranking data (step S145). As a result, the priority attraction-in ranking data becomes

When it is determined that all the bits 0 to 2 are 0 in the step S142, the CPU 31 determines whether all the bits 3 to 7 are 0 or not (step S146). When it is determined that all the bits 3 to 7 are not 0, the CPU 31 determines whether one of the bits 3 to 6 is ON or not (step S147). When it is determined that one of the bits 3 to 6 is ON, the CPU 31 proceeds to the step S144.

When it is determined that one of the bits 3 to 6 is not ON (i.e., the bit 7 representing the stop permission is ON) in the step S147, the CPU 31 determines whether it is after the second stop operation (step S1 48).

When it is determined that it is not after the second stop operation in the step S148, or when it is determined that all the bits 3 to 7 are 0 in the step S146, the CPU 31 adds 1 to the priority attraction-in ranking data (step S149). As a result, the priority attraction-in ranking data becomes ┌00000001┘.

After the process in the step S149, when it is determined that it is after the second stop operation in the step S148, or after the process in the step S145, the CPU 31 adds 1 to the priority attraction-in ranking data (step S150). The priority attraction-in ranking data becomes ┌00000010┘ after the process in the step S149 or the process in the step S145. In addition, when it is determined that it is after the second stop operation in the step S148, the priority attraction-in ranking data becomes ┌00000001┘.

Next, the CPU 31 sets ┌1┘ as an initial value of the priority ranking and sets ┌5┘ as the number of checks (step S151). Next, the CPU 31 sets ┌10000000┘ in the set priority attraction-in data (step S152).

Next, the CPU 31 obtains the attraction-in data of a current priority ranking, based on the priority attraction-in ranking table (step S153). Next, the CPU 31 takes a logical product of the area for storing a winning combination for reel-stop, the display combination storing area and the attraction-in data (step S154). Though this process, it is clarified whether the display combination is included in the winning combination for reel-stop and whether it is matched to the attraction-in data of this priority ranking.

Next, the CPU 31 determines whether the logical product is 0 or not (step S155). When it is determined that the logical product is not 0, the CPU 31 calculates an equation of ┌priority attraction-in ranking data=priority attraction-in ranking data+set priority attraction-in data┘ (step S156). In other words, the CPU 31 takes a logical sum of the priority attraction-in ranking data and the set priority attraction-in data to obtain a result thereof as the priority attraction-in ranking data.

After the process in the step S156 or when it is determined that the result of the logical product in the process of the step S155 is 0, the CPU 31 shifts the bit pattern of the set priority attraction-in data to the right (step S157). For example, if the bit pattern of the set priority attraction-in data is ┌10000000┘ corresponding to the priority ranking 1, it becomes ┌01000000┘.

Next, the CPU adds 1 to the priority ranking and subtracts 1 from the number of checks (step 158). Then, the CPU 31 determines whether the number of checks is 0 or not (step S159). When it is determined that the number of checks is not 0, the CPU 31 proceeds to the step S153.

When it is determined that the number of checks is 0 in the step S159, the CPU 31 stores the priority attraction-in data in the corresponding expected display combination storing area (more specifically, address of the symbol position at this time) (step S160). Like this, the priority attraction-in ranking data is stored every symbol position of the expected display combination storing area, so that the priority attraction-in ranking is determined every symbol arranged on the reels.

Next, the CPU 31 clears the display combination storing area (step S161). Then, the CPU 31 adds 1 to the symbol position and subtracts 1 from the number of symbol checks (step S162).

Next, the CPU 31 determines whether the number of symbol checks is 0 or not (step S163). When it is determined that the number of symbol checks is not 0, the CPU 31 proceeds to the step S134 in FIG. 28.

When it is determined that the number of symbol checks is 0 in the step S163, the CPU 31 copies the symbol positions 0 to 3 (step S164). Thereby, it is possible to rapidly carry out a retrieving process in a priority attraction-in control process which will be described later. Next, the CPU 31 subtracts 1 from the number of display combination retrievals (step S165).

Next, the CPU 31 determines whether the number of display combination retrievals is 0 or not (step S166). When it is determined that the number of display combination retrievals is 0, the CPU 31 ends the expected display combination storing process and proceeds to the process of the step S8 in FIG. 24 or a process of a step S211 in FIG. 31 which will be described later.

When it is determined that the number of display combination retrievals is not 0 in the step S166, the CPU 31 updates the address of the expected display combination storing area (step S167). Specifically, the CPU carries out the update process in order of the expected display combination storing area 1, the expected display combination storing area 2 and the expected display combination storing area 3.

Next, the CPU 31 stores an identifier being rotated in the respective symbol storing areas (step S168). Then, the CPU 31 updates the symbol storing area corresponding to the reel stopped (step S169). When this process is over, the CPU proceeds to the step S133 in FIG. 28.

In the followings, a display combination retrieving process is described with reference to FIG. 30.

First, the CPU 31 sets a leading address of the symbol storing area and acquires an activated line counter (step S181). Specifically, the CPU sets a leading address of the symbol storing area corresponding to the center line 8c. In addition, 5 is stored in the activated line counter.

Then, the CPU 31 determines whether the activated line counter is 0 or not (step S182). When it is determined that the activated line counter is 0, the CPU 31 ends the display combination retrieving process and proceeds to the process of the step S14 in FIG. 24 or the step S137 in FIG. 28.

When it is determined that the activated line counter is not 0 in the step S182, the CPU 31 determines whether the number of display combination retrievals is 0 or not (step S183).

When it is determined that the number of display combination retrievals is 0, the CPU 31 sets the symbol combination table (step S184).

When it is determined that the number of display combination retrievals is not 0 in the step S183, the CPU 31 determines whether the retrieval target is the left reel 3L or not (step S185).

When it is determined that the retrieval target is the left reel 3L in the step S185, the CPU 31 determines and sets the type of the symbol combination table for stop-control, based on the symbol combination table selecting table A for stop-control (step S186). For example, if the activated line counter is 5, the type of the symbol combination table for stop-control is determined, based on the types of the symbols of the left reel 3L which are stored in the symbol storing area corresponding to the center line 8c.

When it is determined that the retrieval target is not the left reel 3L in the step S185, the CPU 31 determines and sets the type of the symbol combination table for stop-control, based on the symbol combination table selecting table B for stop-control (step S187).

After the process of the step S187, after the process of the step S186 or after the process of the step S184, the CPU 31 determines a display combination, based on the symbol storing area except the symbol storing area in which the identifier being rotated is stored (step S188). In this process, when the number of display combination retrievals is 0, it is referred to the symbol combination table, and when the number of display combination retrievals is not 0, it is referred to the symbol combination table selecting table for stop-control.

Next, the CPU 31 stores a logical sum of the determined display combination and the display combination storing area in the display combination storing area (step S189).

Next, the CPU 31 determines whether the number of display combination retrievals is 0 or not (step S190). When it is determined that the number of display combination retrievals is 0, the CPU 31 refers to the symbol combination table to determine the payout number, and updates the payout number counter, based on the determined display combination and the insertion number counter (step S191).

After the process of the step S191, or when it is determined that the number of display combination retrievals is not 0 in the step S190, the CPU 31 determines whether all the symbol combinations are checked (step S192). In this process, when the number of display combination retrievals is 0, it is checked whether all the symbol combinations defined in the symbol combination table are checked, and when the number of display combination retrievals is not 0, it is checked whether all the symbol combinations defined in the respective types of the symbol combination table selecting table for stop-control are checked. When it is determined that all the symbol combinations are not checked, the CPU 31 proceeds to the step S188.

When it is determined that all the symbol combinations are checked in the step S192, the CPU 31 updates the address of the symbol storing area and changes the activated line of the retrieval target (step S193). Specifically, the CPU 31 updates the address of the symbol storing area in order of the center line 8c, the top line 8b, the bottom line 8d, the cross-down line 8e and the cross-up line 8a, and changes the activated line of the retrieval target.

Next, the CPU 31 subtracts 1 from the activated line counter (step S194). When this process is over, the CPU proceeds to the step S182. At this time, when the activated line counter is 0, the display combination retrieving process is ended by the process in the step S182.

In the followings, a reel stop control process is described with reference to FIG. 31.

First, the CPU 31 determines whether an active stop button is pushed or not (step S211). Specifically, the CPU determines whether it is detected the push operation for the active stop button through the stop switch 7S. When it is determined that the active stop button is not pushed in the step S211, the CPU 31 repeats the process in the step S211. In the mean time, the CPU 31 may determine whether a predetermined time (for example, 30 sec) has elapsed after the start switch 6S has been ON while determining whether the active stop button is pushed (in order to carry out a so-called automatic stop).

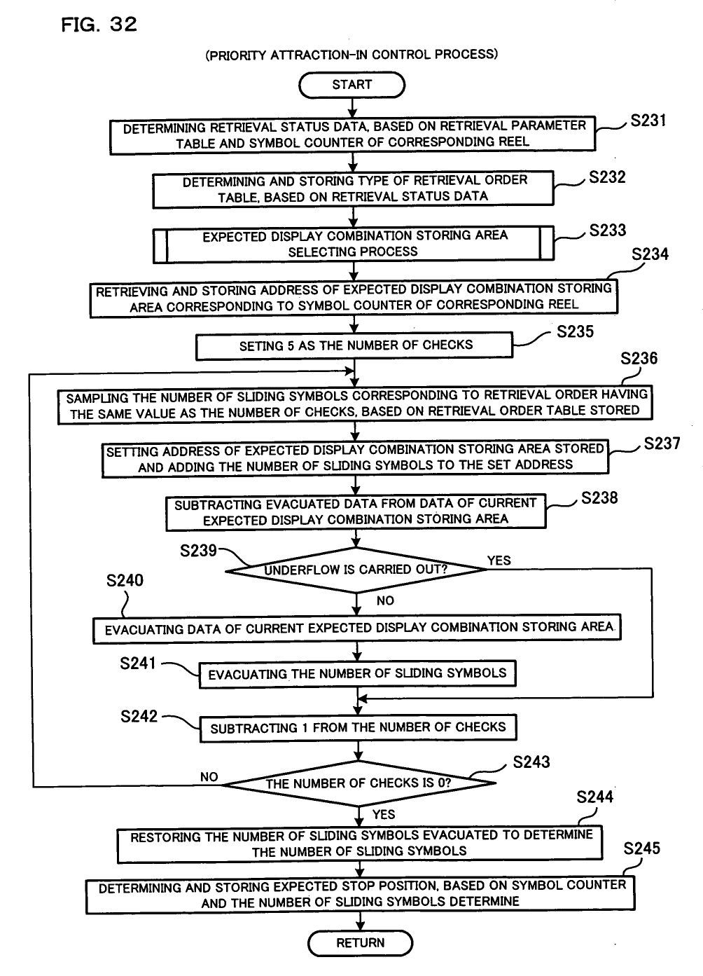

When it is determined that the active stop button is pushed in the step S211, the CPU 31 specifies the type of the stop button for which the push operation is carried out and carries out a priority attraction-in control process which will be described with reference to FIG. 32 (step S212). In the priority attraction-in control process, it is compared the priority attraction-in ranking data relating to all the symbol positions within a range of 4 symbols from the symbol position corresponding to the symbol counter at the time when the push operation is detected on the basis of the expected display combination storing area, and then the symbol position having the highest priority attraction-in ranking is determined as an expected stop position. In the mean time, the priority attraction-in control process constitutes a part of priority ranking comparison means.

Next, the CPU 31 transmits a reel stop command to the sub-control circuit 72 (step S213). The reel stop command includes data of the type of the stopped reel, and the like.

Next, the CPU 31 updates the symbol storing area corresponding to the reel stopped (step S214). For example, after all the reels are stopped, the CPU specifies the types of all the symbols displayed in the display windows 4L, 4C, 4R, based on the symbol counters of all the reels, and stores the specified types in all the symbol storing areas.

Next, the CPU 31 determines whether there is the stop button for which the push operation is not carried out (step S215). When it is determined that there is no the stop button for which the push operation is not carried out, the CPU 31 ends the reel stop control process and proceeds to the step S13 in FIG. 24.

When it is determined that there is the stop button for which the push operation is not carried out in the step S215, the CPU 31 carries out the expected display combination storing process in FIG. 28 (step S216). In this expected display combination storing process, with regard to the reel being rotated except the reel stopped at this time, it is carried out a process of determining the priority attraction-in ranking every symbol of the respective symbol positions of the corresponding reel being rotated. When this process is over, the CPU proceeds to the step S211.

In the followings, a priority attraction-in control process is described with reference to FIG. 32.

First, the CPU 31 determines the retrieval status data, based on the retrieval parameter table and the symbol counter of the corresponding reel (i.e., reel corresponding to the type of the stop button whose stop operation is detected) (step S231). In the mean time, the process in the step S231 constitutes a part of retrieval order determining means.

Next, the CPU 31 determines and stores the type of the retrieval order table, based on the retrieval status data (step S232). Specifically, the leading address of the determined retrieval order table is stored in the RAM 33.

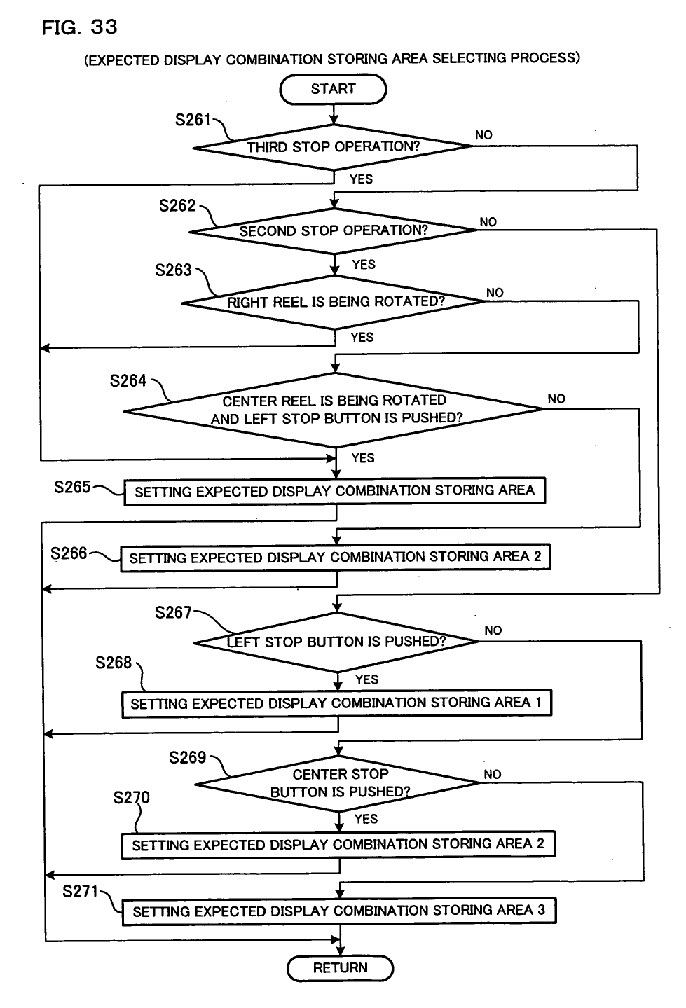

Next, the CPU 31 carries out a process of selecting an expected display combination storing area which will be described with reference to FIG. 33 (step S233). In the process of selecting an expected display combination storing area, it is selected an expected display combination storing area in accordance with the type or the number of reels being rotated.

Next, the CPU 31 retrieves and stores an address of the expected display combination storing area corresponding to the symbol counter of the corresponding reel (step S234).

Next, the CPU 31 sets 5 as the number of checks (step S235). In addition, in this process, a predetermined register in which it is set the priority attraction-in ranking data to be evacuated and a specific register in which it is set the number of sliding symbols to be evacuated are cleared.

Next, the CPU 31 samples the number of sliding symbols corresponding to the retrieval order having the same value as the number of checks, based on the retrieval order table stored (step S236). Thereby, it is possible to sample the number of sliding symbols corresponding, in descending power from the retrieval order 5.

Next, the CPU 31 sets an address of the expected display combination storing area stored and adds the number of sliding symbols to the set address (step S237). For example, if the symbol counter is 16 and the number of sliding symbols is 4, it is obtained an address corresponding to the symbol position 20 of the expected display combination storing area.

Next, the CPU 31 subtracts the evacuated data from the data of the current expected display combination storing area (step S238). Through this process, it is clarified whether the priority attraction-in ranking data of the current expected display combination storing area is greater than the evacuated priority attraction-in ranking data (i.e., whether the priority attraction-in ranking is higher). In the mean time, when the number of checks is 5, the evacuated data is 0.

Next, the CPU 31 determines whether an underflow is carried out or not (step S239). When it is determined that the underflow is not carried out, i.e., when it is determined that the priority attraction-in data of the current expected display combination storing area is equal to or greater than the evacuated priority attraction-in ranking data, the CPU 31 evacuates the priority attraction-in ranking data of the current expected display combination storing area to a predetermined register (step S240). Then, the CPU 31 evacuates the number of sliding symbols to a specific register (step S241).

After the process in the step S241 or when it is determined that the underflow is carried out, i.e., when it is determined that the evacuated priority attraction-in ranking data is greater, the CPU 31 subtracts 1 from the number of checks (step S242).

Next, the CPU 31 determines whether the number of checks is 0 or not (step S243). When it is determined that the number of checks is not 0, the CPU 31 proceeds to the step S236.

When it is determined that the number of checks is 0 in the step S243, the CPU 31 restores the number of sliding symbols evacuated in the specific register to determine the number of sliding symbols (step S244).

Next, the CPU 31 determines and stores an expected stop position, based on the symbol counter and the number of sliding symbols determined (step S245). For example, in case that the symbol counter is 16 and the number of sliding symbols is 3, 19 is determined as the expected stop position and stored in the RAM 33. In addition, when the expected stop position is stored, it is carried out a process of stopping the reels being rotated in an intervention process (see FIG. 36) which will be described later, based on the corresponding expected stop position. When this process is over, the CPU ends the priority attraction-in control process and proceeds to the step S213 in FIG. 31. In the mean time, if one of the number of sliding symbols and the expected stop position is determined, the other is determined. Accordingly, it can be said that they have an equivalent relationship.

In the followings, it is described a process of selecting an expected display combination storing area with reference to FIG. 33.

First, the CPU 31 determines whether it is the third stop operation or not (step S261). When it is determined that it is not the third stop operation, the CPU 31 determines whether it is the second stop operation or not (step S262). When it is determined that it is the second stop operation, the CPU 31 determines whether the right reel 3R is being rotated or not (step S263). When it is determined that the right reel 3R is not being rotated, the CPU 31 determines whether the center reel 3C is being rotated and the stop operation is the push operation for the left stop button 7L (step S264).

When it is determined that the center reel 3C is being rotated and the stop operation is the push operation for the left stop button 7L in the step S264, when it is determined that the right reel 3R is being rotated in the step S263, or when it is determined that it is the third stop operation in the step S231, the CPU 31 sets the expected display combination storing area 1 (step S265). When this process is over, the CPU ends the process of selecting an expected display combination storing area and then proceeds to the step S234 in FIG. 32.

When it is determined that the center reel 3C is being rotated and the stop operation is not the push operation for the left stop button 7L in the step S264, the CPU 31 sets the expected display combination storing area 2 (step S266). When this process is over, the CPU ends the process of selecting an expected display combination storing area and then proceeds to the step S234 in FIG. 32.

When it is determined that it is not the second stop operation in the step S262, the CPU 31 determines whether the stop operation is the push operation for the left stop button 7L (step S267). When it is determined that the stop operation is the push operation for the left stop button 7L, the CPU 31 sets the expected display combination storing area 1 (step S268). When this process is over, the CPU ends the process of selecting an expected display combination storing area and then proceeds to the step S234 in FIG. 32.

When it is determined that the stop operation is not the push operation for the left stop button 7L in the step S267, the CPU 31 determines whether the stop operation is the push operation for the center stop button 7C (step S269). When it is determined that the stop operation is the push operation for the center stop button 7C, the CPU 31 sets the expected display combination storing area 2 (step S270). When this process is over, the CPU ends the process of selecting an expected display combination storing area and then proceeds to the step S234 in FIG. 32.

When it is determined that the stop operation is not the push operation for the center stop button 7C in the step S269, the CPU 31 sets the expected display combination storing area 3 (step S271). When this process is over, the CPU ends the process of selecting an expected display combination storing area and then proceeds to the step S234 in FIG. 32. Like this, the expected display combination storing areas 1, 2 and 3 are sequentially selected, from the reel which is being rotated and nearer at the left side.

In the followings, a bonus operation checking process is described with reference to FIG. 34.

First, the CPU 31 determines whether the display combination is one of RB1, RB2 and RB3 (step S281). When it is determined that the display combination is one of RB1, RB2 and RB3, the CPU 31 carries out the process on RB operation, based on the table on bonus operation (step S282).

Next, the CPU 31 clears the internal carryover combination storing area (step S283). When this process is over, the CPU ends the bonus operation checking process and then proceeds to the step S2 in FIG. 24.

When it is determined that the display combination is not any one of RB1, RB2 and RB3 in the step S281, the CPU 31 determines whether the display combination is Replay or not (step S284). When it is determined that the display combination is not Replay, the CPU 31 ends the bonus operation checking process and then proceeds to the step S2 in FIG. 24.

When it is determined that the display combination is Replay, the CPU 31 copies the insertion number counter to the automatic insertion counter (step S285). In other words, the same value as the insertion number counter is stored in the automatic insertion counter. When this process is over, the CPU ends the bonus operation checking process and then proceeds to the step S2 in FIG. 24.

In the followings, a bonus end checking process is described with reference to FIG. 35.

First, the CPU 31 determines whether a winning is established or not (step S291). When it is determined that the winning is established, the CPU 31 subtracts 1 from the possible winning-number counter (step S292). Then, the CPU 31 determines whether the possible winning-number counter is 0 or not (step S293).

When it is determined that the possible winning-number counter is not 0 in the step S293, or when it is determined that the winning is not established in the step S291, the CPU 31 subtracts 1 from the possible game-number counter (step S294). Then, the CPU 31 determines whether the possible game-number counter is 0 or not (step S295).

When it is determined that the possible game-number counter is not 0 in the step S295, the CPU 31 ends the bonus end checking process and then proceeds to the step S21 in FIG. 24.

When it is determined that the possible game-number counter is 0 in the step S295, or when it is determined that the possible winning-number counter is 0 in the step S293, the CPU 31 carries out a process on RB ending (step S296). In the process on RB ending, the respective data stored at the time when the RB is operated is cleared. When this process is over, the CPU ends the bonus end checking process and then proceeds to the step S21 in FIG. 24.

In the followings, it is described an intervention process having a period of 1.1173 ms which is carried out under control of the CPU 31 of the main control circuit 71, with reference to FIG. 36.

First, the CPU 31 evacuates a register (step S301). Next, the CPU 31 checks an input port (step S302). Specifically, the CPU 31 checks signal inputs from each switch and the like.

Next, the CPU 31 carries out a reel control process (step S303). Specifically, in case that it is a request for rotation start of the reel, the CPU 31 starts to rotate the reels 3L, 3C, 3R and carries out the rotation at a constant speed. In addition, in case that the expected stop position is stored, the CPU waits until the symbol counter of the corresponding reel is updated to the same value as the expected stop position, and then stops the rotation of the corresponding reel. For example, if the symbol counter is ┌16┘ and the expected stop position is ┌19┘, the CPU stops the rotation of the reel when symbol counter is updated to ┌19┘. In the mean time, the reel control process constitutes a part of reel rotating means. In addition, the reel control process constitutes a part of reel stop means.

Next, the CPU 31 performs a lamp×7SEG driving process (step S304). Specifically, the CPU 31 turns on the BET lamps 9a, 9b, 9c in accordance with the insertion number counter and displays the payout number relating to the winning establishment on the information display unit 18, etc.

Next, the CPU 31 carries out a restore of the register (step S305). When this process is over, the CPU ends the intervention process having a period of 1.1173 ms.

In the followings, it is specifically described a process from after an internal winning combination is determined until the priority attraction-in ranking data is stored in the expected display combination storing area.

In case that the gaming state is the normal gaming state in the internal lottery process, there is no internal carryover combination and the random number of 2184 is sampled, the winning number 3 (i.e., Watermelon) is determined and the data ┌000000100┘ is stored in the internal winning combination storing area.

In the reel stop initialization process, the data ┌00000100┘ stored in the internal winning combination storing area is copied to the area for storing a winning combination for reel-stop.

In the expected display combination storing process, since no stop button has not been pushed, 3 is stored as the number of display combination retrievals. In addition, it is set the address of the symbol position ┌0┘ of the expected display combination storing area 1 and the left reel 3L is stored as the retrieval target reel.

In addition, since the symbol position of the left reel 3L is ┌0┘, the symbol arrangement table is referred to, so that the symbol type of the symbol position ┌0┘, the symbol type of the symbol position ┌1┘ over one regarding the symbol position ┌0┘ and the symbol type of the symbol position ┌20┘ under one regarding the symbol position ┌0┘ are specified and respectively stored in the symbol storing area. In other words, Bell, Red 7 and Watermelon are respectively stored with regard to the upper, central and lower parts of the left reel 3L of the symbol storing area.

In the display combination retrieving process, display combinations corresponding to the respective activated lines are determined, based on the symbol combination table selecting table for stop-control A, the symbol combination table for stop-control and the symbol storing area. In other words, the stop avoidance and RB1 in the type 1, Watermelon in the type 4 and Bell in the type 5 are determined as the display combination and a result of a logical sum of these display combinations, i.e., ┌11000110┘ is stored in the display combination storing area.

In the expected display combination storing process, it is carried out a process of taking an exclusive logical sum, based on the data ┌00000100┘ stored in the area for storing a winning combination for reel-stop and the data ┌11000110┘ stored in the display combination storing area, and the priority attraction-in ranking data ┌00000010┘ is obtained.

Next, ┌1┘ is set as an initial value of the priority ranking and ┌5┘ is set as the number of checks, so that it is carried out the check on the priority ranking as the corresponding number of checks, as follows.

First, the priority attraction-in ranking table is referred to and the attraction-in data ┌00001000┘ corresponding to the priority ranking 1 (i.e., Replay) is acquired. Then, when it is taken a logical product of the attraction-in data ┌00001000┘, the data ┌00000100┘ of the area for storing a winning combination for reel-stop and the data ┌11000110┘ of the display combination storing area, the resulting data becomes 0. Accordingly, the priority attraction-in ranking data is not updated, the priority ranking is added by 1 and the number of checks is subtracted by 1. In addition, the bit pattern of the set priority attraction-in data (initial value is ┌10000000┘) is shifted to the right, so that it becomes ┌01000000┘.

Likewise, the attraction-in data ┌01110000┘ corresponding to the priority ranking 2 (i.e., RB) is acquired. Then, when it is taken a logical product of the attraction-in data ┌01110000┘, the data ┌00000100┘ of the area for storing a winning combination for reel-stop and the data ┌11000110┘ of the display combination storing area, the resulting data becomes 0. Accordingly, the priority attraction-in ranking data is not updated, the priority ranking is added by 1 and the number of checks is subtracted by 1. In addition, the bit pattern of the set priority attraction-in data is shifted to the right, so that it becomes ┌00100000┘.

Next, the attraction-in data ┌00000010┘ corresponding to the priority ranking 3 (i.e., Bell) is acquired. Then, when it is taken a logical product of the attraction-in data ┌00000010┘, the data ┌00000100┘ of the area for storing a winning combination for reel-stop and the data ┌11000110┘ of the display combination storing area, the resulting data becomes 0. Accordingly, the priority attraction-in ranking data is not updated, the priority ranking is added by 1 and the number of checks is subtracted by 1. In addition, the bit pattern of the set priority attraction-in data is shifted to the right, so that it becomes ┌00010000┘.

Next, the attraction-in data ┌00000100┘ corresponding to the priority ranking 4 (i.e., Watermelon) is acquired. Then, when it is taken a logical product of the attraction-in data ┌00000100┘, the data ┌00000100┘ of the area for storing a winning combination for reel-stop and the data ┌1000110┘ of the display combination storing area, the resulting data becomes ┌00000100┘. Accordingly, it is taken a logical sum of the priority attraction-in ranking data ┌00000010┘ and the set priority attraction-in data ┌00010000┘, so that the priority attraction-in ranking data is updated to ┌00010010┘. The priority ranking is added by 1 and the number of checks is subtracted by 1. In addition, the bit pattern of the set priority attraction-in data is shifted to the right, so that it becomes ┌00001000┘.

Next, the attraction-in data ┌00000001┘ corresponding to the priority ranking 5 (i.e., Cherry) is acquired. Then, when it is taken a logical product of the attraction-in data ┌00000001┘, the data ┌00000100┘ of the area for storing a winning combination for reel-stop and the data ┌11000110┘ of the display combination storing area, the resulting data becomes 0. Accordingly, the priority attraction-in ranking data ┌00010010┘ is not updated, the priority ranking is added by 1 and the number of checks is subtracted by 1. In addition, the bit pattern of the set priority attraction-in data is shifted to the right, so that it becomes ┌00000100┘.

As a consequence, the number of checks becomes 0 and the current priority attraction-in ranking data ┌00010010┘ is stored in the symbol position ┌0┘ of the expected display combination storing area 1. Thereby, the priority attraction-in ranking is determined with regard to Red 7 of the symbol position ┌0┘ of the left reel 3L.

In the same manner, it is carried the above process from the symbol position ┌1┘ to the symbol position ┌20┘ of the left reel 3L and the priority attraction-in ranking data is stored in the respective symbol positions of the expected display combination storing area 1. When the priority attraction-in ranking data is stored in all the symbol positions, it results in the storing example of the first stop operation time shown in FIG. 23A. In addition, the above process is also carried out for the center reel 3C (or right reel 3R) and the priority attraction-in ranking data is stored in the respective symbol positions of the expected display combination storing area 2 (or expected display combination storing area 3).

In the mean time, in the expected display combination storing process carried out after the first stop operation (or second stop operation), the type of the symbol displayed in the display window is stored in the symbol storing area in accordance with the symbol counter of the stopped reel and the respective symbol positions of the retrieval target reel. Then, based on the types of the symbol stored in the symbol storing area, the symbol combination table for stop-control is referred to and the display combination is retrieved.

For example, in case that the left reel 3L is stopped, when the symbol counter of the left reel 3L is ┌19┘ and the symbol position of the retrieval target reel 3C is ┌0┘, a storing example of the symbol storing area is as follows. In other words, Watermelon of the symbol position ┌20┘, Replay of the symbol position ┌19┘ and Bell of the symbol position ┌18┘ are respectively stored with regard to the upper, central and lower parts of the left reel 3L. In addition, Bell of the symbol position ┌1┘, Red 7 of the symbol position ┌0┘ and Watermelon of the symbol position ┌20┘ are respectively stored with regard to the upper, central and lower parts of the retrieval target reel 3C.

In the mean time, in the above storing example, the data ┌00000000┘ is stored in the display combination storing area, based on the symbol combination table for stop-control. If the process is carried out as described above, the priority attraction-in ranking data is determined as ┌00000010┘ and stored in the symbol position ┌0┘ of the expected display combination storing area 1. In the same manner, when the priority attraction-in ranking data is stored for all the symbol positions of the retrieval target reel 3C, it results in the storing example of the second stop operation time shown in FIG. 23A.

In the followings, it is specifically described a process until the rotation of reel is stopped, based on the expected display combination storing area in which the priority attraction-in ranking data is stored as described above, with reference to the storing example of the expected display combination storing area in FIG. 23.

Hereinafter, with reference to FIG. 23A, it is described a case where the push operation is detected in order of the left stop button 7L, the center stop button 7C and the right stop button 7R and the symbol counter is respectively ┌16┘ at the time when the push operation is detected.

In the reel stop initialization process, it is determined the retrieval parameter table for Watermelon corresponding to the winning number 3.

First, the first stop operation is described. In the priority attraction-in control process, based on the retrieval parameter table for Watermelon, the left reel 3L and the symbol counter ┌16┘, ┌3┘ is determined as the retrieval status data and the retrieval order table 3 is determined.

In the process of selecting the expected display combination storing area, since the first stop operation is the push operation for the left stop button 7L, the leading address of the expected display combination storing area 1 is set (in the register).

In the priority attraction-in control process, 5 is set as the number of checks and the check on the number of sliding symbols is carried out as the corresponding number of checks.

First, the retrieval order table 3 is referred to, and the number of sliding symbols ┌4┘ corresponding to the retrieval order (i.e., retrieval order ┌5┘) same as the number of checks ┌5┘ is sampled and added to the address corresponding to the symbol position ┌16┘ of the expected display combination storing area 1. Then, it is acquired the data ┌00010010┘ of the expected display combination storing area (i.e. symbol position ┌16┘+┌4┘=┌20┘) stored in the address obtained by the addition.

Since the underflow is not carried out when the data (┌0┘ since it is not evacuated) evacuated to a predetermined register is subtracted from the data, the data ┌00010010┘ of the expected display combination storing area of the current address is evacuated to the predetermined register and the number of sliding symbols ┌4┘ is evacuated to a specific register. The number of checks is subtracted by 1.

Likewise, the number of sliding symbols ┌2┘ corresponding to the number of checks ┌4┘ is sampled and the data ┌00000010┘ of the corresponding expected display combination storing area (i.e., symbol position ┌16┘+┌2┘)=┌18┘)is obtained.

Since the underflow is carried out when the data ┌00010010┘ evacuated to the predetermined register is subtracted from the data, it is not carried out the evacuation for the data of the expected display combination storing area and the number of checks is subtracted by 1.

Next, the number of sliding symbols ┌0┘ corresponding to the number of checks ┌3┘ is sampled and the data ┌00000000┘ of the corresponding expected display combination storing area (i.e., symbol position ┌16┘+┌0┘)=┌16┘) is obtained.

Since the underflow is carried out when the data ┌00010010┘ evacuated to the predetermined register is subtracted from the data, it is not carried out the evacuation for the data of the expected display combination storing area and the number of checks is subtracted by 1.

Next, the number of sliding symbols ┌1┘ corresponding to the number of checks ┌2┘ is sampled and the data ┌00000000┘ of the corresponding expected display combination storing area (i.e., symbol position ┌16┘+┌1┘)=┌17┘) is obtained.

Since the underflow is carried out when the data ┌00010010┘ evacuated to the predetermined register is subtracted from the data, it is not carried out the evacuation for the data of the expected display combination storing area and the number of checks is subtracted by 1.

Next, the number of sliding symbols ┌3┘ corresponding to the number of checks ┌1┘ is sampled and the data ┌00010010┘ of the corresponding expected display combination storing area (i.e., symbol position ┌16┘+┌3┘)=┌19┘) is obtained.

Since the underflow is not carried out when the data ┌00010010┘ evacuated to the predetermined register is subtracted from the data, the data ┌00010010┘ is evacuated to the predetermined register and the number of sliding symbols ┌3┘ is evacuated to the specific register. The number of checks is subtracted by 1.

As a result, the number of checks becomes 0 and the number of sliding symbols ┌3┘ evacuated to the specific register is restored.

Based on the symbol position ┌16┘ and the number of sliding symbols ┌3┘, ┌19┘ is determined as the expected stop position. The rotation of the left reel 3L is stopped at the expected stop position ┌19┘, so that Watermelon, Replay and Bell are displayed in the upper, central and lower parts of the left display window 4L.

In the followings, the second stop operation is described. In the priority attraction-in control process, based on the retrieval parameter table for Watermelon, the center reel 3C and the symbol counter ┌16┘, ┌0┘ is determined as the retrieval status data and the retrieval order table 0 is determined.

In the process of selecting the expected display combination storing area, since the second stop operation is the push operation for the center stop button 7C, the leading address of the expected display combination storing area 1 is set (in the register).

In the priority attraction-in control process, 5 is set as the number of checks and the check on the number of sliding symbols is carried out as the corresponding number of checks.

First, the retrieval order table 0 is referred to, the number of sliding symbols ┌3┘ corresponding to the retrieval order (i.e., retrieval order ┌5┘) same as the number of checks ┌5┘ is sampled and added to the address corresponding to the symbol position ┌16┘ of the expected display combination storing area 1. Then, it is acquired the data ┌00010010┘ of the expected display combination storing area (i.e. symbol position ┌16┘+┌3┘=┌19┘) stored in the address obtained by the addition.

Since the underflow is not carried out when the data (┌0┘, because it is not evacuated) evacuated to a predetermined register is subtracted from the data, the data ┌00010010┘ of the expected display combination storing area of the current address is evacuated to the predetermined register and the number of sliding symbols ┌3┘ is evacuated to a specific register. The number of checks is subtracted by 1.

Likewise, the number of sliding symbols ┌1┘ corresponding to the number of checks ┌4┘ is sampled and the data ┌00000010┘ of the corresponding expected display combination storing area (i.e., symbol position ┌16┘+┌1┘)=┌17┘)is obtained.

Since the underflow is carried out when the data ┌00010010┘ evacuated to the predetermined register is subtracted from the data, it is not carried out the evacuation for the data of the expected display combination storing area and the number of checks is subtracted by 1.

Next, the number of sliding symbols ┌4┘ corresponding to the number of checks ┌3┘ is sampled and the data ┌00010010┘ of the corresponding expected display combination storing area (i.e., symbol position ┌16┘+┌4┘)=┌20┘) is obtained.

Since the underflow is not carried out when the data ┌00010010┘ evacuated to the predetermined register is subtracted from the data, the data ┌00010010┘ is evacuated to the predetermined register and the number of sliding symbols ┌4┘ is evacuated to the specific register. The number of checks is subtracted by 1.

Next, the number of sliding symbols ┌2┘ corresponding to the number of checks ┌2┘ is sampled and the data ┌00000010 ┘ of the corresponding expected display combination storing area (i.e., symbol position ┌16┘+┌2┘)=┌18┘) is obtained.

Since the underflow is carried out when the data ┌00010010┘ evacuated to the predetermined register is subtracted from the data, it is not carried out the evacuation for the data of the expected display combination storing area and the number of checks is subtracted by 1.

Next, the number of sliding symbols ┌0┘ corresponding to the number of checks ┌1┘ is sampled and the data ┌00000010┘ of the corresponding expected display combination storing area (i.e., symbol position ┌16┘+┌0┘)=┌16┘) is obtained.

Since the underflow is carried out when the data ┌00010010┘ evacuated to the predetermined register is subtracted from the data, it is not carried out the evacuation for the data of the expected display combination storing area and the number of checks is subtracted by 1.

As a result, the number of checks becomes 0 and the number of sliding symbols ┌4┘ evacuated to the specific register is restored.

Based on the symbol position ┌16┘ and the number of sliding symbols ┌4┘, ┌20┘ is determined as the expected stop position. The rotation of the center reel 3C is stopped at the expected stop position ┌20┘, so that Red 7, Watermelon and Cherry are displayed in the upper, central and lower parts of the center display window 4C.

In the followings, the third stop operation is described. In the priority attraction-in control process, based on the retrieval parameter table for Watermelon, the right reel 3R and the symbol counter ┌16┘, ┌2┘ is determined as the retrieval status data and the retrieval order table 2 is determined.

In the process of selecting the expected display combination storing area, since the third stop operation is the push operation for the right stop button 7R, the leading address of the expected display combination storing area 1 is set (in the register).

In the priority attraction-in control process, 5 is set as the number of checks and the check on the number of sliding symbols is carried out as the corresponding number of checks.

First, the retrieval order table 2 is referred to, the number of sliding symbols ┌3┘ corresponding to the retrieval order (i.e., retrieval order ┌5┘) same as the number of checks ┌5┘ is sampled and added to the address corresponding to the symbol position ┌16┘ of the expected display combination storing area 1. Then, it is acquired the data ┌00000010┘ of the expected display combination storing area (i.e. symbol position ┌16┘+┌3┘=┌19┘) stored in the address obtained by the addition.

Since the underflow is not carried out when the data (┌0┘, because it is not evacuated) evacuated to the predetermined register is subtracted from the data, the data ┌00000010┘ of the expected display combination storing area of the current address is evacuated to the predetermined register and the number of sliding symbols ┌3┘ is evacuated to the specific register. The number of checks is subtracted by 1.

Likewise, the number of sliding symbols ┌1┘ corresponding to the number of checks ┌4┘ is sampled and the data ┌00000010┘ of the corresponding expected display combination storing area (i.e., symbol position ┌16┘+┌1┘)=┌17┘)is obtained.

Since the underflow is not carried out when the data ┌00000010┘ evacuated to the predetermined register is subtracted from the data, the data ┌00000010┘ is evacuated to the predetermined register and the number of sliding symbols ┌1┘ is evacuated to the specific register. The number of checks is subtracted by 1.

Next, the number of sliding symbols ┌0┘ corresponding to the number of checks ┌3┘ is sampled and the data ┌00000010┘ of the corresponding expected display combination storing area (i.e., symbol position ┌16┘+┌0┘)=┌16┘) is obtained.

Since the underflow is not carried out when the data ┌00000010┘ evacuated to the predetermined register is subtracted from the data, the data ┌00000010┘ is evacuated to the predetermined register and the number of sliding symbols ┌0┘ is evacuated to the specific register. The number of checks is subtracted by 1.

Next, the number of sliding symbols ┌4┘ corresponding to the number of checks ┌2┘ is sampled and the data ┌00000010┘ of the corresponding expected display combination storing area (i.e., symbol position ┌16┘+┌4┘)=┌20┘) is obtained.

Since the underflow is not carried out when the data ┌00010010┘ evacuated to the predetermined register is subtracted from the data, the data ┌00000010┘ is evacuated to the predetermined register and the number of sliding symbols ┌4┘ is evacuated to the specific register. The number of checks is subtracted by 1.

Next, the number of sliding symbols ┌2┘ corresponding to the number of checks ┌1┘is sampled and the data ┌00010010┘ of the corresponding expected display combination storing area (i.e., symbol position ┌16┘+┌2┘)=┌18┘) is obtained.

Since the underflow is not carried out when the data ┌00000010┘ evacuated to the predetermined register is subtracted from the data, the data ┌00010010┘ is evacuated to the predetermined register and the number of sliding symbols ┌2┘ is evacuated to the specific register. The number of checks is subtracted by 1.

As a result, the number of checks becomes 0 and the number of sliding symbols ┌2┘ evacuated to the specific register is restored.

Based on the symbol position ┌16┘ and the number of sliding symbols ┌2┘, ┌18┘ is determined as the expected stop position. The rotation of the right reel 3R is stopped at the expected stop position ┌18┘, so that BAR, Replay and Watermelon are displayed in the upper, central and lower parts of the right display window 4R.

Accordingly, three Watermelons are arranged and displayed along the cross-down line 8e in the display windows 4L, 4C, 4R and Watermelon is determined as the display combination in the display combination retrieving process.

Hereinafter, with reference to FIG. 23B, it is described a case where the data ┌01000100┘ is stored in the internal winning combination storing area, the push operation is detected in order of the left stop button 7L, the center stop button 7C and the right stop button 7R and the symbol counter is ┌16┘ at the rime when the push operation is detected.

The case where the data ┌01000100┘ is stored in the internal winning combination storing area is as follows: the random number of 1785 is sampled and the winning number 3 (i.e., Watermelon) and the winning number 7 (i.e., RB1) are together determined in the internal lottery process, or the random number of 2184 is sampled and the winning number 3 (i.e., Watermelon) is determined, as a case where RB1 is carried over.

In the reel stop initialization process, it is determined the retrieval parameter table for Watermelon corresponding to the winning number 3.

First, the first stop operation is described. In the priority attraction-in control process, based on the retrieval parameter table for Watermelon, the left reel 3L and the symbol counter ┌16┘, ┌3┘ is determined as the retrieval status data and the retrieval order table 3 is determined.

In the process of selecting the expected display combination storing area, since the first stop operation is the push operation for the left stop button 7L, the leading address of the expected display combination storing area 1 is set (in the register).

In the priority attraction-in control process, 5 is set as the number of checks and the check on the number of sliding symbols is carried out as the corresponding number of checks.

First, the retrieval order table 3 is referred to, the number of sliding symbols ┌4┘ corresponding to the retrieval order (i.e., retrieval order ┌5┘) same as the number of checks ┌5┘ is sampled and added to the address corresponding to the symbol position ┌16┘ of the expected display combination storing area 1. Then, it is acquired the data ┌01010010┘ of the expected display combination storing area (i.e. symbol position ┌16┘+┌4┘=┌20┘) stored in the address obtained by the addition.

Since the underflow is not carried out when the data (┌0┘, because it is not evacuated) evacuated to a predetermined register is subtracted from the data, the data ┌010100101┘ of the expected display combination storing area of the current address is evacuated to the predetermined register and the number of sliding symbols ┌4┘ is evacuated to the specific register. The number of checks is subtracted by 1.

Likewise, the number of sliding symbols ┌2┘ corresponding to the number of checks ┌4┘ is sampled and the data ┌00000010┘ of the corresponding expected display combination storing area (i.e., symbol position ┌16┘+┌2┘)=┌18┘) is obtained.

Since the underflow is carried out when the data ┌01010010┘ evacuated to the predetermined register is subtracted from the data, it is not carried out the evacuation for the data of the expected display combination storing area and the number of checks is subtracted by 1.

Next, the number of sliding symbols ┌0┘ corresponding to the number of checks ┌3┘ is sampled and the data ┌00000000┘ of the corresponding expected display combination storing area (i.e., symbol position ┌16┘+┌0┘)=┌16┘)is obtained.

Since the underflow is carried out when the data ┌01010010┘ evacuated to the predetermined register is subtracted from the data, it is not carried out the evacuation for the data of the expected display combination storing area and the number of checks is subtracted by 1.

Next, the number of sliding symbols ┌1┘ corresponding to the number of checks ┌2┘ is sampled and the data ┌00000000┘ of the corresponding expected display combination storing area (i.e., symbol position ┌16┘+┌1┘)=┌17┘) is obtained.

Since the underflow is carried out when the data ┌01010010┘ evacuated to the predetermined register is subtracted from the data, it is not carried out the evacuation for the data of the expected display combination storing area and the number of checks is subtracted by 1.

Next, the number of sliding symbols ┌3┘ corresponding to the number of checks ┌1┘ is sampled and the data ┌00010010┘ of the corresponding expected display combination storing area (i.e., symbol position ┌16┘+┌3┘)=┌19┘) is obtained.

Since the underflow is carried out when the data ┌01010010┘ evacuated to the predetermined register is subtracted from the data, it is not carried out the evacuation for the data of the expected display combination storing area and the number of checks is subtracted by 1.

As a result, the number of checks becomes 0 and the number of sliding symbols ┌4┘ evacuated to the specific register is restored.

Based on the symbol position ┌16┘ and the number of sliding symbols ┌4┘, ┌20┘ is determined as the expected stop position. The rotation of the left reel 3L is stopped at the expected stop position ┌20┘, so that Red 7, Watermelon and Replay are displayed in the upper, central and lower parts of the left display window 4L.

In other words, in case that only Watermelon is determined as the internal winning combination as described above, it is carried out the attraction-in for only Watermelon, even though the symbol counter at the time when the stop operation is detected is the same ┌16┘. To the contrary, in case that both Watermelon and RB1 are determined as the internal winning combination, it is carried out the attraction-in for Watermelon and Red 7 relating to the internal winning combinations.

Accordingly, contrary to the conventional gaming machine where the first symbol position is determined as the expected stop position, it is possible to leave some room for a possibility that the symbol combinations relating to both the internal winning combinations will be displayed. As a result, it is possible to solve such problem that even though it is carried out the stop operation at the timing at which the symbol having the higher priority attraction-in ranking can be attracted-in, the corresponding symbol is not attracted-in. Accordingly, it is possible to prevent the payout to be naturally awarded to the player from being lost.

In addition, the player performs the stop operation at the timing at which the stop starting position becomes same in cases where only Watermelon is the internal winning combination and both Watermelon and RB1 are the internal winning combination, and observes the attraction-in modes of the symbols located at the corresponding stop starting position, so that the player can perceive whether RB1 is also determined as the internal winning combination.

In the followings, the second stop operation is described. In the priority attraction-in control process, based on the retrieval parameter table for Watermelon, the center reel 3C and the symbol counter ┌16┘, ┌0┘ is determined as the retrieval status data and the retrieval order table 0 is determined.

In the process of selecting the expected display combination storing area, since the second stop operation is the push operation for the center stop button 7C, the leading address of the expected display combination storing area 1 is set (in the register).

In the priority attraction-in control process, 5 is set as the number of checks and the check on the number of sliding symbols is carried out as the corresponding number of checks.

First, the retrieval order table 0 is referred to, the number of sliding symbols ┌3┘ corresponding to the retrieval order (i.e., retrieval order ┌5┘) same as the number of checks ┌5┘ is sampled and added to the address corresponding to the symbol position ┌16┘ of the expected display combination storing area 1. Then, it is acquired the data ┌00000010┘ of the expected display combination storing area (i.e. symbol position ┌16┘+┌3┘=┌19┘) stored in the address obtained by the addition.

Since the underflow is not carried out when the data (┌0┘, because it is not evacuated) evacuated to the predetermined register is subtracted from the data, the data ┌00000010┘ of the expected display combination storing area of the current address is evacuated to the predetermined register and the number of sliding symbols ┌3┘ is evacuated to the specific register. The number of checks is subtracted by 1.

Likewise, the number of sliding symbols ┌1┘ corresponding to the number of checks ┌4┘ is sampled and the data ┌00000010┘ of the corresponding expected display combination storing area (i.e., symbol position ┌16┘+┌1┘)=┌17┘)is obtained.

Since the underflow is not carried out when the data ┌00000010┘ evacuated to the predetermined register is subtracted from the data, the data ┌00000010┘ is evacuated to the predetermined register and the number of sliding symbols ┌1┘ is evacuated to the specific register. The number of checks is subtracted by 1.

Next, the number of sliding symbols ┌4┘ corresponding to the number of checks ┌3┘ is sampled and the data ┌00010010┘ of the corresponding expected display combination storing area (i.e., symbol position ┌16┘+┌4┘)=┌20┘) is obtained.

Since the underflow is not carried out when the data ┌00000010┘ evacuated to the predetermined register is subtracted from the data, the data ┌00000010┘ is evacuated to the predetermined register and the number of sliding symbols ┌4┘ is evacuated to the specific register. The number of checks is subtracted by 1.

Next, the number of sliding symbols ┌2┘ corresponding to the number of checks ┌2┘ is sampled and the data ┌00000010┘ of the corresponding expected display combination storing area (i.e., symbol position ┌16┘+┌2┘)=┌18┘) is obtained.

Since the underflow is carried out when the data ┌00010010┘ evacuated to the predetermined register is subtracted from the data, it is not carried out the evacuation for the data of the expected display combination storing area and the number of checks is subtracted by 1.

Next, the number of sliding symbols ┌0┘ corresponding to the number of checks ┌1┘ is sampled and the data ┌00000010┘ of the corresponding expected display combination storing area (i.e., symbol position ┌16┘+┌0┘)=┌16┘) is obtained.

Since the underflow is carried out when the data ┌00010010┘ evacuated to the predetermined register is subtracted from the data, it is not carried out the evacuation for the data of the expected display combination storing area and the number of checks is subtracted by 1.

As a result, the number of checks becomes 0 and the number of sliding symbols ┌4┘ evacuated to the specific register is restored.

Based on the symbol position ┌16┘ and the number of sliding symbols ┌4┘, ┌20┘ is determined as the expected stop position. The rotation of the center reel 3C is stopped at the expected stop position ┌20┘, so that Red 7, Watermelon and Cherry are displayed in the upper, central and lower parts of the center display window 4C. In other words, in the same way as the first stop operation, both Watermelon and Red 7 are attracted-in.

In the followings, the third stop operation is described. In the priority attraction-in control process, based on the retrieval parameter table for Watermelon, the right reel 3R and the symbol counter ┌16┘, ┌2┘ is determined as the retrieval status data and the retrieval order table 2 is determined.

In the process of selecting the expected display combination storing area, since the third stop operation is the push operation for the right stop button 7R, the leading address of the expected display combination storing area 1 is set (in the register).

In the priority attraction-in control process, 5 is set as the number of checks and the check on the number of sliding symbols is carried out as the corresponding number of checks, as follows.

First, the retrieval order table 2 is referred to, the number of sliding symbols ┌3┘ corresponding to the retrieval order (i.e., retrieval order ┌5┘) same as the number of checks ┌5┘ is sampled and added to the address corresponding to the symbol position ┌16┘ of the expected display combination storing area 1. Then, it is acquired the data ┌00000010┘ of the expected display combination storing area (i.e. symbol position ┌16┘+┌3┘=┌19┘) stored in the address obtained by the addition.

Since the underflow is not carried out when the data (┌0┘, because it is not evacuated) evacuated to the predetermined register is subtracted from the data, the data ┌00000010┘ of the expected display combination storing area of the current address is evacuated to the predetermined register and the number of sliding symbols ┌3┘ is evacuated to the specific register. The number of checks is subtracted by 1.

Likewise, the number of sliding symbols ┌1┘ corresponding to the number of checks ┌4┘ is sampled and the data ┌00000010┘ of the corresponding expected display combination storing area (i.e., symbol position ┌16┘+┌1┘)=┌17┘) is obtained.

Since the underflow is not carried out when the data ┌00000010┘ evacuated to the predetermined register is subtracted from the data, the data ┌00010010┘ is evacuated to the predetermined register and the number of sliding symbols ┌1┘ is evacuated to the specific register. The number of checks is subtracted by 1.

Next, the number of sliding symbols ┌0┘ corresponding to the number of checks ┌3┘ is sampled and the data ┌00000010┘ of the corresponding expected display combination storing area (i.e., symbol position ┌16┘+┌0┘)=┌16┘) is obtained.

Since the underflow is carried out when the data ┌00010010┘ evacuated to the predetermined register is subtracted from the data, it is not carried out the evacuation for the data of the expected display combination storing area and the number of checks is subtracted by 1.

Next, the number of sliding symbols ┌4┘ corresponding to the number of checks ┌2┘ is sampled and the data ┌01000010┘ of the corresponding expected display combination storing area (i.e., symbol position ┌16┘+┌4┘)=┌20┘) is obtained.

Since the underflow is not carried out when the data ┌00010010┘ evacuated to the predetermined register is subtracted from the data, the data ┌01000010┘ is evacuated to the predetermined register and the number of sliding symbols ┌4┘ is evacuated to the specific register. The number of checks is subtracted by 1.

Next, the number of sliding symbols ┌2┘ corresponding to the number of checks ┌4┘ is sampled and the data ┌00000010┘ of the corresponding expected display combination storing area (i.e., symbol position ┌16┘+┌2┘)=┌18┘) is obtained.

Since the underflow is not carried out when the data ┌01000010┘ evacuated to the predetermined register is subtracted from the data, it is not carried out the evacuation for the data of the expected display combination storing area and the number of checks is subtracted by 1.

As a result, the number of checks becomes 0 and the number of sliding symbols ┌4┘ evacuated to the specific register is restored.

Based on the symbol position ┌16┘ and the number of sliding symbols ┌4┘, ┌20┘ is determined as the expected stop position. The rotation of the right reel 3R is stopped at the expected stop position ┌20┘, so that Red 7, Bell and BAR are displayed in the upper, central and lower parts of the right display window 4R. Accordingly, three Red 7s are arranged and displayed along the top line 8b in the display windows 4L, 4C, 4R and RB1 is determined as the display combination in the display combination retrieving process.

Like this, in the third stop operation, in case that there are both Watermelon and Red 7 in a range of 4 symbols from the symbol position corresponding to the symbol counter at the time when it is carried out the detection of stop operation, the symbol Red 7 having the higher priority attraction-in ranking is displayed, based on the expected display combination storing area.

In the specific example referring to FIG. 23B, it has been described the case where the symbol counter of the right reel 3R when the third stop operation is detected is ┌16┘. However, in the followings, it is described a case where the symbol counter of the right reel 3R when the third stop operation is detected is ┌0┘. In the mean time, since the first and second stop operations are same as the above cases, the descriptions thereof are omitted.

In the priority attraction-in control process, based on the retrieval parameter table for Watermelon, the right reel 3R and the symbol counter ┌0┘, ┌1┘ is determined as the retrieval status data and the retrieval order table 1 is determined.

In the process of selecting the expected display combination storing area, since the third stop operation is the push operation for the right stop button 7R, the leading address of the expected display combination storing area 1 is set (in the register).

In the priority attraction-in control process, 5 is set as the number of checks and the check on the number of sliding symbols is carried out as the corresponding number of checks, as follows.

First, the retrieval order table 1 is referred to, the number of sliding symbols ┌4┘ corresponding to the retrieval order (i.e., retrieval order ┌5┘) same as the number of checks ┌5┘ is sampled and added to the address corresponding to the symbol position ┌0┘ of the expected display combination storing area 1. Then, it is acquired the data ┌00010010┘ of the expected display combination storing area (i.e. symbol position ┌0┘+┌4┘=┌4┘) stored in the address obtained by the addition.

Since the underflow is not carried out when the data (┌0┘, because it is not evacuated) evacuated to the predetermined register is subtracted from the data, the data ┌00010010┘ of the expected display combination storing area of the current address is evacuated to the predetermined register and the number of sliding symbols ┌4┘ is evacuated to the specific register. The number of checks is subtracted by 1.

Likewise, the number of sliding symbols ┌2┘ corresponding to the number of checks ┌4┘ is sampled and the data ┌0000010┘ of the corresponding expected display combination storing area (i.e., symbol position ┌0┘+┌2┘)=┌2┘) is obtained.

Since the underflow is carried out when the data ┌00010010┘ evacuated to the predetermined register is subtracted from the data, it is not carried out the evacuation for the data of the expected display combination storing area and the number of checks is subtracted by 1.

Next, the number of sliding symbols ┌0┘ corresponding to the number of checks ┌3┘ is sampled and the data ┌00000010┘ of the corresponding expected display combination storing area (i.e., symbol position ┌0┘+┌0┘)=┌0┘) is obtained.

Since the underflow is carried out when the data ┌00010010┘ evacuated to the predetermined register is subtracted from the data, it is not carried out the evacuation for the data of the expected display combination storing area and the number of checks is subtracted by 1.

Next, the number of sliding symbols ┌3┘ corresponding to the number of checks ┌2┘ is sampled and the data ┌00000010┘ of the corresponding expected display combination storing area (i.e., symbol position ┌0┘+┌3┘)=┌3┘) is obtained.

Since the underflow is carried out when the data ┌00010010┘ evacuated to the predetermined register is subtracted from the data, it is not carried out the evacuation for the data of the expected display combination storing area and the number of checks is subtracted by 1.

Next, the number of sliding symbols ┌1┘ corresponding to the number of checks ┌1┘ is sampled and the data ┌00000010┘ of the corresponding expected display combination storing area (i.e., symbol position ┌0┘+┌1┘)=┌1┘) is obtained.

Since the underflow is carried out when the data ┌01000010┘ evacuated to the predetermined register is subtracted from the data, it is not carried out the evacuation for the data of the expected display combination storing area and the number of checks is subtracted by 1.

As a result, the number of checks becomes 0 and the number of sliding symbols ┌4┘ evacuated to the specific register is restored.

Based on the symbol position ┌0┘ and the number of sliding symbols ┌4┘, ┌4┘ is determined as the expected stop position. The rotation of the right reel 3R is stopped at the expected stop position ┌4┘, so that Replay, Watermelon and Bell are displayed in the upper, central and lower parts of the right display window 4R. Accordingly, three Watermelons are arranged and displayed along the center line 8c in the display windows 4L, 4C, 4R and Watermelon is determined as the display combination in the display combination retrieving process.

Like this, in case that both Watermelon and RB1 are determined as the internal winning combination, when there is only Watermelon in a range of 4 symbols from the symbol position corresponding to the symbol counter at the time when it is carried out the detection of stop operation, the expected stop position is determined so that the corresponding Watermelon is displayed.

As described above, according to the gaming machine 1 of the embodiment, for each of the symbols (i.e., symbols of the symbol positions ┌0┘˜┌20┘) arranged on the reels, the priority attraction-in ranking is determined in accordance with the type of the corresponding symbol and the type of the internal winning combination and then stored in the expected display combination storing area. In other words, it is possible to carry out the relative evaluation between the symbols arranged on the reels by referring to the expected display combination storing areas.

When the stop operation is detected, it is retrieved all the symbols ranging from the symbol located at the symbol position corresponding to the symbol counter at that time to 4 symbols, based on the corresponding symbol counter and the expected display combination storing area, and the priority attraction-in rankings determined in the retrieved symbols are respectively compared. Then, based on the symbol having the highest priority attraction-in ranking as a result of the comparison, the rotation of reels is stopped.

Accordingly, when the stop operation is detected, it is retrieved the most suitable symbol, among all the symbols ranging from the symbol located at the symbol position corresponding to the symbol counter at that time to 4 symbols and the rotation of reel is stopped on the basis of the most suitable symbol, so that it is possible to prevent the payout to be awarded to the player from being lost.

In addition, based on the priority attraction-in ranking table defining the priority rankings corresponding to the types of the internal winning combinations, for each of the symbols arranged on the reels, the priority attraction-in ranking is determined in correspondence with the type of the corresponding symbols and the type of the determined internal winning combination. Accordingly, it is possible to cope with the change of the gaming machine just by changing the priority rankings defined in the priority attraction-in ranking table. In addition, since it is possible to group the different internal winning combinations, such as RB1, RB2 and RB3 and to define the same priority ranking for them, it is possible to reduce the types of values (for example, bit strings allotted to the respective internal winning combinations of the priority attraction-in ranking data) taken as the priority attraction-in ranking and thus to decrease the data capacity.

Further, for each of all the symbols of the respective reels, the priority attraction-in ranking is determined in accordance with the type of the corresponding symbol, the types of the symbols adjacent to the corresponding symbol and the type of the determined internal winning combination. Accordingly, since it is referred to the types of the types of the symbols adjacent to the corresponding symbol as well as the type of the corresponding symbol, it is possible to determine the priority attraction-in rankings more specifically, as compared to the case where the priority attraction-in rankings are determined on the basis of the type of the single symbol.

In addition, when the stop operation is detected, the one symbol is determined, based on the symbol counter at that time, the expected display combination storing area, and the retrieval order table in which the retrieval orders of the number of sliding symbols ┌0┘ to ┌4┘ are defined. Accordingly, even though there are the plural symbols having the same priority attraction-in ranking, it is possible to detect the one symbol having the higher retrieval order, based on the corresponding retrieval orders.

Additionally, even though the stop starting positions are different, it is possible to make the expected stop positions same depending on the setting of the retrieval order table. Thereby, it is possible to make the number of the expected stop positions small, within a range in which the combinations of symbols are possible. In other words, it is not necessary for the player to remember the many patterns displayed.

As described above, the gaming machine according to the above embodiment comprises: the plural reels, each of which having plural symbols arranged on a periphery thereof and displaying the symbols; the start operation detection means (for example, start switch 6S) for detecting a start operation; the internal winning combination determining means (for example, internal lottery process in FIG. 26, main control circuit 71) for determining an internal winning combination on the basis of the start operation detection carried out by the start operation detection means; the reel rotation means (for example, reel control process in the step S303 of FIG. 36, stepping motors 49L, 49C, 49R, main control circuit 71) for rotating the reels; the priority ranking determining means (for example, expected display combination storing process in FIGS. 28 and 29, main control circuit 71) for determining a priority attraction-in ranking (for example, priority attraction-in ranking data) based on an internal winning combination determined by the internal winning combination determining means and a type of the symbol, for each of the symbols (for example, symbol positions ┌0┘˜┌20┘) arranged on the reels; the stop operation detection means (for example, stop switch 7S) for detecting a stop operation; the symbol specifying means (for example, symbol counter, symbol arrangement table, main control circuit 71) for specifying a symbol of a predetermined position (for example, center line 8c); the priority ranking comparison means (for example, priority attraction-in control process in FIG. 32, main control circuit 71) for comparing the priority attraction-in rankings related to each of the symbols ranging from a symbol specified by the symbol specifying means to symbols within a predetermined range (for example, a range of 4 symbols), when the stop operation is detected by the stop operation detection means; and the reel stop means (for example, reel control process in the step S303 of FIG. 36, main control circuit 71) for stopping rotation of the reels when a symbol having the highest priority attraction-in ranking as a result of the comparison carried out by the priority ranking comparison means reaches the predetermined position.

In addition, the gaming machine according to the above embodiment further comprises the priority attraction-in ranking table memorizing means (for example, ROM 32) for memorizing the priority attraction-in ranking table defining the priority rankings in accordance with the internal winning combinations, wherein the priority ranking determining means determines the priority attraction-in ranking depending on the internal winning combination determined by the internal winning combination determining means and the type of the symbol, for each of the symbols arranged on the reels, based on the priority attraction-in ranking table memorized by the priority attraction-in ranking table memorizing means.

In addition, in the gaming machine according to the above embodiment, the priority ranking determining means determines the priority attraction-in ranking depending on the internal winning combination determined by the internal winning combination determining means, the type of the symbol (for example, the type of the symbol of the symbol position ┌0┘) and types of symbols adjacent to the corresponding symbol (for example, the type of the symbol of the symbol position ┌1┘ and the type of the symbol of the symbol position ┌20┘), for each of the symbols arranged on the reels.

Further, the gaming machine according to the above embodiment further comprises the retrieval order table memorizing means (for example, ROM 32) for memorizing the retrieval order table defining the plural types of retrieval orders and the retrieval order determining means (for example, processes in the steps S231 and S232 of FIG. 32, main control circuit 71) for determining one of the plural retrieval orders defined in the retrieval order table, wherein the priority ranking comparison means compares the priority attraction-in rankings relating to the respective symbols ranging from the symbol specified by the symbol specifying means to the symbol within the predetermined range when the stop operation is detected by the stop operation detection means, and determines the symbol having the highest priority attraction-in ranking in accordance with the retrieval orders defined in the retrieval order table.

According to the above gaming machine, the symbol having the highest priority attraction-in ranking is determined depending on one of the plural retrieval orders defined in the retrieval order table. Accordingly, it is possible to diversify the combinations of symbols displayed when the reels are stopped in accordance with the stop operation. In addition, it is possible to provide the undulations from after the stop operation is carried out until the reels are stopped. Further, in case that there are a plurality of symbols having the highest priority attraction-in ranking, among the respective symbols from the symbol specified by the symbol specifying means to the symbols within the predetermined range, it is possible to determine one symbol in accordance with the retrieval orders. In addition, in such case, even though the symbols specified by the symbol specifying means are same, it is possible to make the type of the symbol determined different in accordance with the different retrieval order.

In the mean time, regarding the reel, the start operation detection means, the internal winning combination determining means, the reel rotation means, the priority ranking determining means, the stop operation detection means, the priority ranking comparison means, the reel stop means, the priority attraction-in ranking table memorizing means, the retrieval order table memorizing means, the retrieval order determining means and the like, which constitute the gaming machine, the specific structures thereof are not limited to each element described in the above embodiment and can be changed.

In the above embodiment, it has been structured such that the priority attraction-in ranking is higher as the upper bit is ON (i.e., 1) (i.e., the greater the value) and the symbol position determined to have the highest value as the priority attraction-in ranking data is a symbol having the highest priority attraction-in ranking. However, the invention is not limited thereto and a structure of the priority attraction-in data can be arbitrarily modified. In other words, it may be structured such that the priority attraction-in ranking is higher as the lower bit is ON (i.e., 1) (i.e., the smaller the value), and the symbol position determined to have the smallest value as the priority attraction-in ranking data may be a symbol having the highest priority attraction-in ranking. In this case, it is possible to match the bit 0 to Replay, the bit 1 to ┌RB1, RB2, RB3┘, the bit 2 to Bell, the bit 3 to Watermelon, the bit 4 to Cherry, the bit 6 to the stop possibility and the bit 7 to the stop avoidance. In addition, the stop prohibition may be achieved by making all the bits ON.

In addition, in the above embodiment, the reel index is detected so that the symbol of the symbol position ┌0┘ is located at the center line 8c and the symbol on the center line 8c is specified by the symbol counter (in other words, the center line 8c has been applied as the predetermined position). However, the invention is not limited thereto. In other words, the position at which the symbol is specified by the symbol counter may be arbitrarily changed. For example, the reel index may be detected so that the symbol of the symbol position ┌0┘ is located at the top line 8b (specifically, a central part of the upper area of the respective display windows 4L, 4C, 4R) or bottom line 8b (specifically, a central part of the lower area of the respective display windows 4L, 4C, 4R).

For example, in case that the bottom line 8b is applied, the symbol on the bottom line 8b is specified by the symbol counter. In this case, it is displayed in the display windows the symbol of the symbol position corresponding to the symbol counter, the symbol of the symbol position over one, regarding the symbol position corresponding to the symbol counter and the symbol of the symbol position over two, regarding the symbol position corresponding to the symbol counter. For example, when the symbol counter is ┌15┘, it is displayed in the display windows the symbol of the symbol position ┌15┘, the symbol of the symbol position ┌16┘ and the symbol of the symbol position ┌17┘. Accordingly, even when the position at which the symbol specified by the symbol counter is located is changed, the types of the symbols which can be displayed in the display windows are stored in the symbol storing area and the priority attraction-in ranking data is determined, based on it.

In addition, in the above embodiment, RB1, RB2 and RB3 have been grouped in the priority attraction-in ranking table and given with one priority ranking. However, the invention is not limited thereto. For example, it is possible to arbitrarily change the type of the internal winning combination which will be grouped, such as Watermelon, Cherry, etc. In this case, it is preferred to apply the type which has not been simultaneously determined as the internal winning combination.

In addition, in the above embodiment, the three display windows 4L, 4C, 4R have been provided to correspond to the reels 3L,3C, 3R, respectively. However, the number of display windows is not limited to 3. For example, a single display window may be provided. It is enough that the display window can display three symbols of the symbols arranged on the respective reels 3L, 3C, 3R.

Additionally, in the above embodiment, the bit pattern of the set priority attraction-in data has been shifted to the right whenever 1 is added to the priority rankings of the priority attraction-in ranking table (see the step S157 in FIG. 29). However, the invention is not limited thereto. For example, it may be such structured that the set priority attraction-in data relating to the priority rankings 1 to 5 is defined in the priority attraction-in table in advance and the set priority attraction-in data is read whenever 1 is added to the priority rankings. Thereby, it is possible to reduce the program capacity related to the above processes.

In addition, in the above embodiment, the number of sliding symbols has been sequentially read from the lower retrieval order (i.e., the retrieval order 5). However, the invention is not limited thereto. For example, if it is structured such that the number of sliding symbols having the higher retrieval order is preferentially read, the number of sliding symbols may be read from the higher retrieval order.

In addition, the symbol combination table for stop-control has been used in the display combination retrieving process of the expected display combination storing process. However, the invention is not limited thereto and a symbol combination table may be used. In the above embodiment, since the display combination retrieving process can be carried out for each of the types by providing the symbol combination table for stop-control, it is possible to reduce the number of retrievals and to rapidly carry out the process relating to the retrieval, as compared to the symbol combination table. However, if the symbol combination table is together provided, it is possible to suppress the increase of the memory capacity of the ROM in a case where the symbol combination table for stop-control is provided.

In addition, the device structures shown in FIGS. 1 and 2, the circuit structure and the peripheral device thereof shown in FIG. 3, the structures of tables shown in FIGS. 4 to 16, the structures of storing areas of the RAM shown in FIGS. 17 to 22, the flow charts shown in FIGS. 14 to 36 and the like, which have been applied to the above embodiment, may be arbitrarily changed or modified without departing the scope of the invention.

Further, in addition to the pachi-slot machine as described in the embodiment, the invention can be applied to another gaming machine such as slot machine, pachinko gaming machine, arrange ball, mahjong ball gaming machine, video slot, video poker and the like. Additionally, the invention can be applied to a game program which pseudo-executes the operations of the above pachi-slot machine as a home gaming machine, thereby executing a game. In this case, a medium for recording the game program may include a CD-ROM, FD (flexible disk) and the other recording media.

In addition, the effects described in the embodiment are only enumerations of the most preferred effects obtainable from the invention and the effects of the invention are not limited to the embodiments.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising:
plural reels, each of which having plural symbols arranged on a periphery thereof and displaying the symbols;
start operation detection means for detecting a start operation;
internal winning combination determining means for determining an internal winning combination on the basis of the start operation detection carried out by the start operation detection means;
reel rotation means for rotating the reels;
priority ranking determining means for determining a priority attraction-in ranking, based on an internal winning combination determined by the internal winning combination determining means and a type of the symbol, for each of the symbols arranged on the reels;
stop operation detection means for detecting a stop operation;
symbol specifying means for specifying a symbol of a predetermined position;
priority ranking comparison means for comparing the priority attraction-in rankings related to each of the symbols ranging from a symbol specified by the symbol specifying means to symbols within a predetermined range, when the stop operation is detected by the stop operation detection means; and
reel stop means for stopping rotation of the reels when a symbol having the highest priority attraction-in ranking as a result of the comparison carried out by the priority ranking comparison means reaches the predetermined position.

2. The gaming machine according to claim 1, further comprising priority attraction-in ranking table memorizing means for memorizing a priority attraction-in ranking table defining the priority rankings in accordance with internal winning combinations, wherein the priority ranking determining means determines the priority attraction-in ranking depending on the internal winning combination determined by the internal winning combination determining means and the type of the symbol, for each of the symbols arranged on the reels, based on the priority attraction-in ranking table memorized by the priority attraction-in ranking table memorizing means.

3. The gaming machine according to claim 1, wherein the priority ranking determining means determines the priority attraction-in ranking depending on the internal winning combination determined by the internal winning combination determining means, the type of the symbol and types of symbols adjacent to the corresponding symbol, for each of the symbols arranged on the reels.
